(19) United States
(12) Patent Application Publication
(10) Pub. No.: US 2023/0339018 A1
(43) Pub. Date: Oct. 26, 2023

(54) METAL MAGNETIC POWDER, COMPOSITE MAGNETIC BODY, AND ELECTRONIC COMPONENT

(71) Applicant: TDK CORPORATION, Tokyo (JP)

(72) Inventors: Kyohei TAKAHASHI, Tokyo (JP); Hiroshi ITO, Tokyo (JP); Isao KANADA, Tokyo (JP); Akito HASEGAWA, Tokyo (JP)

(73) Assignee: TDK CORPORATION, Tokyo (JP)

(21) Appl. No.: 18/302,517

(22) Filed: Apr. 18, 2023

(30) Foreign Application Priority Data
Apr. 21, 2022 (JP) 2022-070117

(51) Int. Cl. B22F 1/102; B22F 1/145; B22F 1/16; B22F 9/24; H01F 1/09

(52) U.S. Cl. CPC B22F 1/102; B22F 1/145; B22F 1/16; B22F 9/24; H01F 1/09

(57) ABSTRACT

A metal magnetic powder includes Co as a main component, and the metal magnetic powder includes metal nanoparticles having a mean particle size (D50) of 1 nm or more and 100 nm or less. Each of the metal nanoparticles includes hcp-Co as a main phase, and the metal magnetic powder includes at least one amphoteric metal.

### TECHNICAL FIELD

The present disclosure relates to a metal magnetic powder containing metal nanoparticles including Co as a main component, a composite magnetic body, and an electronic component.

### BACKGROUND

In recent years, operation frequencies range up to a gigahertz band (for example, 3.7 GHz band (3.6 to 4.2 GHz) and 4.5 GHz band (4.4 to 4.9 GHz band)), in high-frequency circuits included in various communication devices, such as a mobile phone and a wireless LAN device. Examples of electronic components mounted on such high-frequency circuits include an inductor, an antenna, and a filter for high frequency noise suppression. Although an air-core coil having a non-magnetic core is generally used as a coil incorporated in such electronic components for high frequency applications, there is a demand for development of a magnetic material applicable to the electronic components for high frequency applications in order to improve properties of these electronic components.

For example, Patent Document 1 discloses a magnetic material made of metal nanoparticles for high frequency applications. The metal nanoparticles can reduce the number of magnetic domains per unit particle as compared with micrometer-order metal magnetic particles, and can reduce the eddy current loss in the high frequency band. However, even in the magnetic material disclosed Patent Document 1, when the operating frequency exceeds 1 GHz, the permeability extremely decreases (FIG. 2 of Patent Document 1), and the magnetic loss increases.

Patent Document 1: JP 2006303298 A

### SUMMARY

The present disclosure has been made in view of the above circumstances, and an object thereof is to provide a metal magnetic powder having a high permeability and a low magnetic loss in a high frequency region of a gigahertz band, and a composite magnetic body and an electronic component which contain the metal magnetic powder.

To achieve the above object, a metal magnetic powder according to the present disclosure includes Co as a main component,
wherein the metal magnetic powder comprises metal nanoparticles having a mean particle size (D50) of 1 nm or more and 100 nm or less,
wherein each of the metal nanoparticles comprises hcp-Co as a main phase, and
wherein the metal magnetic powder includes at least one amphoteric metal.

Since the metal magnetic powder of the present disclosure has the above characteristics, it is possible to obtain both the high permeability and the low magnetic loss in the high frequency region of the gigahertz band.

Preferably, the amphoteric metal is present on a surface and/or inside of at least one of the metal nanoparticles.

Preferably, W_{AM}/(W_{Co}+W_{AM}) is 0.001% or more and 10% or less, where W_{Co} denotes a content rate of Co, and W_{AM} denotes a content rate of amphoteric metals, in the metal magnetic powder.

Preferably, the metal magnetic powder includes Zn as the amphoteric metal.

Preferably, the metal magnetic powder comprises fcc-Co and/or ϵ-Co as a sub-phase.

A composite magnetic body according to the present disclosure includes a metal magnetic powder including Co as a main component and a resin,
wherein the metal magnetic powder comprises metal nanoparticles having a mean particle size (D50) of 1 nm or more and 100 nm or less,
each of the metal nanoparticles comprises hcp-Co as a main phase, and
the composite magnetic body includes at least one amphoteric metal.

Since the composite magnetic body according to the present disclosure has the above characteristics, it is possible to suitably achieve both the high permeability and the low magnetic loss in the high frequency region of the gigahertz band.

Preferably, W_{AM}/(W_{Co}+W_{AM}) is 0.001% or more and 10% or less,
where W_{Co} denotes a content rate of Co, and W_{AM} denotes a content rate of amphoteric metals, in the metal magnetic powder.

Preferably, the composite magnetic body includes Zn as the amphoteric metal.

Preferably, the metal magnetic powder contained in the composite magnetic body comprises fcc-Co and/or ϵ-Co as a sub-phase.

The metal magnetic powder and the composite magnetic body described above can be suitably used in electronic components such as an inductor, an antenna, and a filter mounted on a high frequency circuit.

### BRIEF DESCRIPTION OF THE DRAWINGS

FIG. 1 is a schematic diagram illustrating a metal magnetic powder 1 according to an embodiment of the present disclosure;

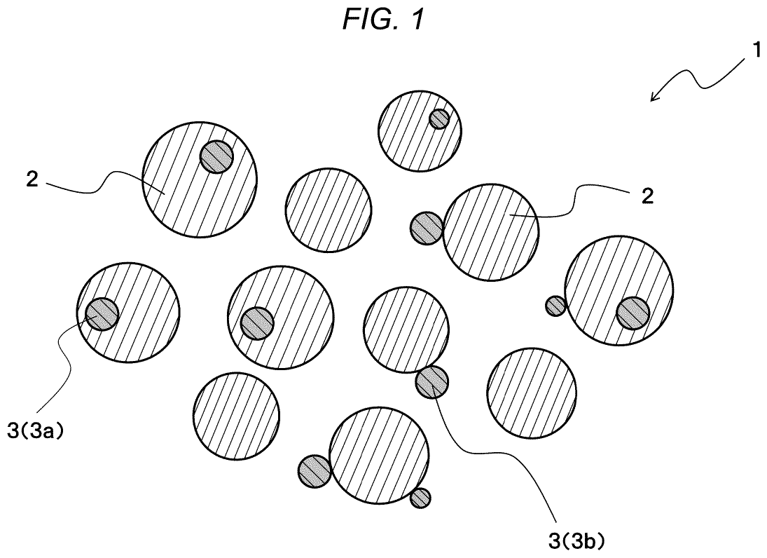

FIG. 2 is a schematic diagram illustrating a cross section of a composite magnetic body containing the metal magnetic powder 1 illustrated in FIG. 1;

FIG. 3 is an example of X-ray diffraction patterns of the metal magnetic powder 1; and

FIG. 4 is a schematic diagram of a cross-section illustrating an example of an electronic component containing the composite magnetic body 10 illustrated in FIG. 2.

### DETAILED DESCRIPTION

Hereinafter, the present disclosure is described in detail on the basis of an embodiment shown in the figures.

### Metal Magnetic Powder 1

A metal magnetic powder 1 according to the present embodiment is comprised of nanoparticles 2 (metal nanoparticles). A mean particle size of the nanoparticles 2 (that is, a mean particle size of the metal magnetic powder 1) is 1 nm or more and 100 nm or less. The mean particle size of the nanoparticles 2 may be calculated by measuring an equivalent circular diameter of each of the nanoparticles 2 using a transmission electron microscope (TEM). Specifically, the metal magnetic powder 1 is observed with the TEM at a magnification of 500,000 times or more, and the equivalent circular diameter of each of the nanoparticles 2 included in an observation field of view is measured with image analysis software. At this time, it is preferable to measure equivalent circular diameters of at least 500 nanoparticles 2, and a cumulative frequency distribution on a number basis is obtained based on the measurement results. Then, an equivalent circular diameter at which the cumulative frequency is 50% in the cumulative frequency distribution is calculated as the mean particle size (D50) of the nanoparticles 2.

The mean particle size (D50) of the nanoparticles 2 is preferably 70 nm or less, and more preferably 50 nm or less. As the mean particle size of the nanoparticles 2 is reduced, a magnetic loss (tanδ) of the metal magnetic powder 1 tends to be further reduced. Although shapes of the nanoparticles 2 are not particularly limited, manufacturing methods shown in the present embodiment usually yields the nanoparticles 2 having spherical shapes or shapes close to sphere. In addition, each surface of the nanoparticles 2 may have a coating such as an oxide layer or an insulating layer.

The metal magnetic powder 1 includes cobalt (Co) as a main component. That is, the nanoparticles 2 are Co nanoparticles including Co as the main component. Note that the “main component” means an element occupying 80 wt % or more in the metal magnetic powder 1. The metal magnetic powder 1 preferably includes 90 wt % or more of Co, more preferably 93 wt % or more of Co.

The metal magnetic powder 1 includes at least one of amphoteric metals in addition to Co. The amphoteric metals mean four elements of aluminum (Al), zinc (Zn), tin (Sn), and lead (Pb), and the metal magnetic powder 1 preferably includes Zn as the amphoteric metal. W_{AM}/(W_{Co}+W_{AM}) is preferably 0.001% or more (10 ppm or more) and 10% or less, and more preferably 1% or more and 7% or less, where W_{Co} (wt %) denotes a content rate of Co in the metal magnetic powder 1 and W_{AM} (wt %) denotes a content rate of the amphoteric metals in the metal magnetic powder 1. In a case where the metal magnetic powder 1 includes two or more amphoteric metals, W_{AM} is a sum of content rates of the amphoteric metals.

The metal magnetic powder 1 may include other trace elements such as Cl, P, C, Si, N, and O. A total content rate of the other trace elements (elements other than Co and amphoteric metals) in the metal magnetic powder 1 is preferably less than 20 wt %.

A composition (W_{Co}, W_{AM}, W_{AM}/(W_{Co}+W_{AM}), or the like) of the metal magnetic powder 1 can be measured by composition analysis using, for example, inductively coupled plasma atomic emission spectrometry (ICP-AES), X-ray diffraction (XRD), X-ray fluorescence spectrometry (XRF), energy dispersive X-ray spectrometry (EDS), wavelength dispersive X-ray spectrometry (WDS), or the like, and is preferably measured by ICP-AES. In the composition analysis by ICP-AES, first, a sample containing the metal magnetic powder 1 is collected in a glove box, and the sample is added to an acid solution such as HNO₃ (nitric acid), and heated and melt. The composition analysis by ICP-AES may be performed using this solutionized sample to quantify Co and each amphoteric metal contained in the sample.

Note that the main component of the metal magnetic powder 1 may be identified on the basis of analysis of X-ray diffraction or the like. For example, a volume rate of each element contained in the metal magnetic powder 1 may be calculated by analysis of X-ray diffraction or the like, and an element having the highest volume rate may be identified as the main component of the metal magnetic powder 1.

A main phase of the metal magnetic powder 1, that is, a main phase of each of the nanoparticles 2 is hcp-Co. This “hcp-Co” means not an alloy phase but a crystalline phase of Co having a hexagonal close-packed structure. Co with massive shape and Co particles with micrometer-order particle size tend to have the hcp structure, but when Co particles have a particle size of 100 nm or less, the main phase tends to be fcc-Co (face-centered cubic structure) or ϵ-Co (a type of cubic crystal). In the present embodiment, the nanoparticles 2 whose main phase is hcp-Co are obtained by predetermined manufacturing methods to be described later.

The metal magnetic powder 1 preferably includes fcc-Co and/or ϵ-Co as a sub-phase of Co with hcp-Co as the main phase. The sub-phase of Co is more preferably present within the nanoparticles 2 along with the main phase of hcp-Co. That is, the metal magnetic powder 1 preferably includes the nanoparticles 2 having a mixed-phase structure of Co (a structure including the main phase and the sub-phase inside the particles) rather than mixing of the nanoparticles 2 having single-phase of hcp-Co and the other nanoparticles having single-phase of fcc-Co or ϵ-Co. In this case, all the nanoparticles 2 may have the mixed-phase structure, or the nanoparticles 2 having hcp-Co (the nanoparticles 2 not including the sub-phase of Co) and the nanoparticles 2 having the mixed-phase structure (nanoparticles 2 including the sub-phase of Co) may be present together. When the metal magnetic powder 1 includes the sub-phase of Co, a permeability tends to be further improved.

Note that the “main phase” means a crystalline phase occupying 50% or more of the metal magnetic powder 1. Specifically, a proportion of hcp-Co is W_{hcp}, a proportion of fcc-Co is W_{fcc}, a proportion of ϵ-Co is W_{ϵ}, and W_{hcp}+W_{fcc}+W_{ϵ} is 100% in the metal magnetic powder 1, a crystalline phase occupying 50% or more is defined as the main phase. That is, it is determined that the main phase of the metal magnetic powder 1 is hcp-Co when 50%≤(W_{hcp}/(W_{hcp}+W_{fcc}+W_{ϵ})) is satisfied. In the metal magnetic powder 1, “W_{hcp}/(W_{hcp}+W_{fcc}+W_{ϵ})” denoting a content ratio of hcp-Co is preferably 70% or more and 99% or less, and more preferably 80% or more and 99% or less. When the content ratio of hcp-Co is set within the above range, it is possible to more suitably achieve both the high permeability and the low magnetic loss.

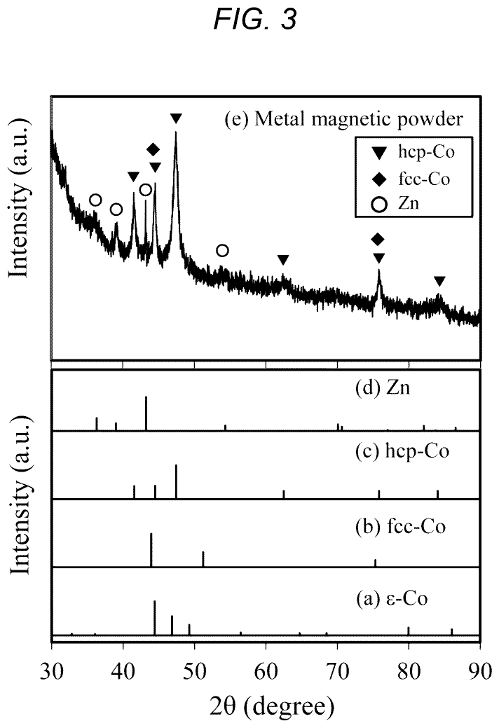

A crystal structure of the metal magnetic powder 1 (that is, a crystal structure of the nanoparticles 2) can be analyzed by X-ray diffraction (XRD). In FIG. 3(e) is an example of an XRD pattern of the metal magnetic powder 1. Note that (a) to (d) in FIG. 3 are all XRD patterns stored in databases such as documents or ICDD, in which (a) is the XRD pattern of ϵ-Co, (b) is the XRD pattern of fcc-Co, (c) is the XRD pattern of hcp-Co, and (d) is the XRD pattern of Zn.

The XRD pattern of the metal magnetic powder 1 as shown in FIG. 3(e) is obtained by 2θ/θ measurement of XRD, and then, profile fitting (peak separation) of the measured XRD pattern is performed using XRD analysis software. Then, crystalline phases included in the metal magnetic powder 1 can be identified by collating separated diffraction peaks with the database. In the XRD pattern shown in FIG. 3(e), peaks indicated by “▾” are peaks derived from hcp-Co, and peaks indicated by “♦” are peaks derived from fcc-Co.

In addition, the proportion of each Co crystalline phase may be calculated on the basis of an integrated intensity of each diffraction peak. Specifically, diffraction peaks included in the XRD pattern (e) are identified by profile fitting, and then, integrated intensities of the identified diffraction peaks are calculated. W_{hcp} is an integrated intensity of diffraction peaks derived from hcp-Co, W_{fcc} is an integrated intensity of diffraction peaks derived from fcc-Co, and W_{ϵ} is an integrated intensity of diffraction peaks derived from ϵ-Co, and “W_{hcp}/(W_{hcp}+W_{fcc}+W_{ϵ})” can be calculated.

In hcp-Co which is the main phase, the amphoteric metals and impurity elements may be slightly solid-dissolved. However, the degree of deviation of a lattice constant of hcp-Co is preferably 0.5% or less. The “degree of deviation of the lattice constant” is represented by (|d_{STD}-d_{f}|)/d_{STD} (%), where d_{STD} denotes a lattice constant of hcp-Co stored in the database, and df denotes a lattice constant of hcp-Co calculated by analyzing an XRD pattern of the metal magnetic powder 1. The lattice constant may be measured by electron diffraction using the TEM.

In addition, the presence or absence of the mixed-phase structure in the nanoparticles 2 can be confirmed by analysis using the TEM, such as a high-resolution electron microscope (HREM), electron backscatter diffraction (EBSD), or electron diffraction. For example, in a case where a crystal structure of each of the nanoparticles 2 is analyzed by electron diffraction using the TEM, at least 50 nanoparticles 2 are irradiated with an electron beam, and whether each of the nanoparticles 2 has a single-phase structure or the mixed-phase structure is determined on the basis of an electron diffraction pattern obtained at that time. In this analysis, it is preferable to select the nanoparticles 2 isolated in the field of view as much as possible and to irradiate the selected nanoparticles with the electron beam.

The amphoteric metal included in the metal magnetic powder 1 is preferably present as crystal grains 3 of the amphoteric metal rather than being solid-dissolved in the main phase (hcp-Co) or included in compounds such as oxides. In other words, the metal magnetic powder 1 preferably includes the crystal grains 3 of the amphoteric metal.

In a case where the metal magnetic powder 1 includes the crystal grains 3 of the amphoteric metal, not only the diffraction peaks of Co but also diffraction peaks of the amphoteric metal are detected in an XRD pattern of the metal magnetic powder 1. Actually, FIG. 3(e) is the XRD pattern when Zn is added as the amphoteric metal, and diffraction peaks of Zn are detected in the XRD pattern (peaks indicated by “o” are the diffraction peaks of Zn). That is, it is found that Zn is present not as the compounds such as the oxides but as metal crystals in the metal magnetic powder 1 shown in FIG. 3(e). In this manner, an existence state of the amphoteric metals can be confirmed by the analysis of the XRD pattern.

In addition, the amphoteric metal is preferably present on a surface and/or inside of at least one of the metal nanoparticles. Specifically, the nanoparticles 2 preferably comprise some nanoparticles 2 having the amphoteric metal on the surface and/or some nanoparticles 2 having the amphoteric metal inside. That is, the metal magnetic powder 1 preferably includes, as the crystal grains 3 of the amphoteric metal, crystal grains 3a that are present insides some nanoparticles 2 and/or crystal grains 3b adhering to surfaces of some nanoparticles 2. In addition, grain sizes of the crystal grains 3 of the amphoteric metal are preferably smaller than the mean particle size (D50) of the nanoparticles 2. The existing locations of the amphoteric metal can be identified by, for example, mapping analysis using TEM-EDS.

### Composite Magnetic Body 10

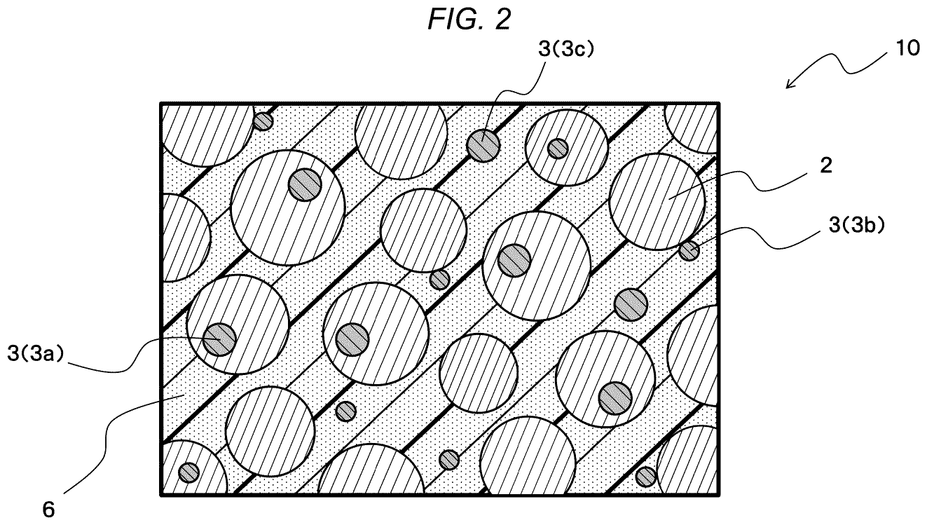

Next, a composite magnetic body 10 including the above-described metal magnetic powder 1 is described with reference to FIG. 2.

The composite magnetic body 10 includes the metal magnetic powder 1 having the above-described characteristics and a resin 6, and the nanoparticles 2 comprising the metal magnetic powder 1 are dispersed in the resin 6. In other words, the resin 6 is interposed between the nanoparticles 2 to insulate adjacent particles from each other. A material of the resin 6 is not particularly limited as long as a resin material having insulating properties is used. For example, a thermosetting resin such as an epoxy resin, a phenol resin, or a silicone resin, or a thermoplastic resin such as an acrylic resin, polyethylene, or polypropylene can be used as the resin 6, and the thermosetting resin is preferable.

An area ratio of the metal magnetic powder 1 in a cross section of the composite magnetic body 10 is preferably 10% to 60%, and more preferably 10% to 40%.

The area ratio of the metal magnetic powder 1 in the cross section of the composite magnetic body 10 can be calculated by observing the cross section of the composite magnetic body 10 using a scanning electron microscope (SEM) or a transmission electron microscope (TEM), and analyzing cross-sectional images using image analysis software. Specifically, the cross-sectional images of the composite magnetic body 10 may be binarized based on contrast, and distinguish the metal magnetic powder 1 from the other part. Then, the ratio of the area occupied by the metal magnetic powder 1 with respect to the entire images (that is, a ratio of a total area of the nanoparticles 2 to a total area of the observed field of views) may be calculated from the binarized cross-sectional images. The area ratio calculated by the above method can be regarded as a volume ratio of the nanoparticles 2 in the composite magnetic body 10.

The amphoteric metal is also preferably present as the crystal grains 3 of the amphoteric metal in the composite magnetic body 10. The composite magnetic body 10 may include the crystal grains 3a that are present insides some nanoparticles 2 and/or crystal grains 3b adhering to surfaces of some nanoparticles 2. In addition, the composite magnetic body 10 may include crystal grains 3c that are dispersed in the resin 6 of the composite magnetic body 10, as the crystal grains 3. It is considered that some of the crystal grains 3b adhering to the surfaces of the nanoparticles 2 detach from the surfaces during the process of mixing the metal magnetic powder 1 and the resin 6, resulting in the production of the crystal grains 3c.

That is, examples of existing locations of the amphoteric metal in the composite magnetic body 10 include three patterns: the insides of some nanoparticles 2 of A; the surfaces of some nanoparticles 2 of B; and in the resin 6 of C. The amphoteric metal in the composite magnetic body 10 may be present in any one pattern of A to C, may be present in any two patterns of A to C, or may be present in all the sites of A to C. The existing locations of the amphoteric metal in the composite magnetic body 10 can be identified by performing mapping analysis using TEM-EDS on the cross section of the composite magnetic body 10.

Even in the case where the metal magnetic powder 1 is included in the composite magnetic body 10, the mean particle size (D50), composition, and crystal structure of the metal magnetic powder 1 can be analyzed by the above-described method (TEM observation, ICP-AES, XRD, or the like). Note that there is a case where an analysis result is affected by a constituent element of the resin 6 when the composition of the metal magnetic powder 1 in the composite magnetic body 10 is analyzed by ICP-AES, XRD, or the like. In such a case, the influence of elements other than Co and the amphoteric metals may be eliminated, and a main component of the metal magnetic powder 1 may be identified only on the basis of W_{AM}/(W_{Co}+W_{AM}).

The composite magnetic body 10 may include ceramic particles, metal particles other than the nanoparticles 2, and the like. In addition, a shape and a dimension of the composite magnetic body 10 are not particularly limited, and may be appropriately determined according to an application.

Hereinafter, examples of methods for manufacturing the metal magnetic powder 1 and the composite magnetic body 10 is described. The metal magnetic powder 1 is preferably manufactured by a liquid phase thermal decomposition method involving a disproportionation reaction or a vapor phase thermal decomposition method. In the liquid phase thermal decomposition method involving the disproportionation reaction or the vapor phase thermal decomposition method, the nanoparticles 2 having hcp-Co as the main phase are likely to be obtained.

### Method for Manufacturing Metal Magnetic Powder 1 by Liquid Phase Thermal Decomposition Accompanied by Disproportionation Reaction

The disproportionation reaction means a reaction in which two or more molecules of one type of substance react with each other to produce two or more types of other substances. In a case where the metal magnetic powder 1 is manufactured by the liquid phase thermal decomposition accompanied by the disproportionation reaction, chlorotris(triphenylphosphine)cobalt (CoCl(Ph₃P)₃) is preferably used as a precursor (Co raw material). In the liquid phase thermal decomposition accompanied by the disproportionation reaction, two types of compounds of Co(0)(Ph₃P)₄ and Co(II)Cl₂(Ph₃P)₂ are produced from the precursor, and Co(0)(Ph₃P)₄ out of these compounds is decomposed to produce the nanoparticles 2 of Co.

In the case where the metal magnetic powder 1 is manufactured by the liquid phase thermal decomposition accompanied by the disproportionation reaction, first, the precursor and an additive including the amphoteric metal are weighed such that the metal magnetic powder 1 has a desired composition. Then, the precursor, the additive, and a solvent are put into a reaction vessel such as a separable flask, and these raw materials are stirred using a mechanical stirrer or the like. As the additive containing the amphoteric metal, for example, chlorides of amphoteric metal such as ZnCl₂, AlCl₃, SnCl₂, and PbCl₂ are preferably used. A ratio of the amphoteric metal (W_{AM}/(W_{AM}+W_{Co})) in the metal magnetic powder 1 can be controlled by a ratio of the additive. As the solvent, ethanol, tetrahydrofuran (THF), or oleylamine is preferably used. Note that a surfactant such as oleic acid may be added.

An atmosphere when performing the liquid phase thermal decomposition accompanied by the disproportionation reaction is preferably an inert gas atmosphere such as an Ar atmosphere. A temperature of a reaction solution during stirring (that is, a reaction temperature) is preferably in a range of 10° C. to 65° C., and more preferably a room temperature (25° C.). In addition, a stirring time (that is, a reaction time) is desirably adjusted appropriately according to the reaction temperature, and is, for example, preferably 0.01 h to 80 h, and more preferably 0.1 h to 72 h when the reaction temperature is the room temperature. As the reaction temperature is raised, a mean particle size of the nanoparticles 2 tends to increase. In addition, a mean particle size of the nanoparticles 2 tends to increase as the reaction time is increased.

The crystal structure of the nanoparticles 2 can be controlled by a type of the solvent, the reaction temperature, and the like. For example, the ratio of hcp-Co (W_{hcp}/(W_{hcp}+W_{fcc}+W_{ϵ})) tends to increase as the reaction temperature is lowered, and the sub-phase (fcc-Co and/or ϵ-Co) is more likely to be produced as the reaction temperature is raised. In a case where ethanol is used as the solvent, the ratio of hcp-Co is likely to be higher than that in a case where another solvent (THF or oleylamine) is used. In a case where THF is used as the solvent, a mixed-phase structure including hcp-Co as the main phase and fcc-Co as the sub-phase is likely to be obtained. In a case where oleylamine is used as the solvent, a mixed-phase structure including three phases of hcp-Co as the main phase and fcc-Co and ϵ-Co as the sub-phases tends to be obtained. In a case where the reaction temperature is set to exceed 40° C. while using oleylamine, a mixed-phase structure including hcp-Co as the main phase and ϵ-Co as the sub-phase is likely to be obtained.

The additive including the amphoteric metal may be added at the start of the reaction, or may be added after a lapse of a predetermined time from the start of the reaction. The existing locations of the amphoteric metal can be controlled by a timing of adding the additive. Specifically, when the additive is added at the start of the reaction, the amphoteric metal is likely to be present inside the nanoparticles 2. On the other hand, when the additive is added after a lapse of (½) RT or more from the start of the reaction assuming a desired reaction time as RT, the amphoteric metal is more likely to be present on the surfaces of the nanoparticles 2 than inside.

After the reaction is stopped by stopping the stirring of the reaction solution, the produced nanoparticles 2 are washed and collected. When the nanoparticles 2 are washed, a washing solvent in which an unreacted raw material, an intermediate product, and the like are soluble is used. For example, as the washing solvent, an organic solvent such as acetone, dichlorobenzene, or ethanol can be used. It is preferable to subject the washing solvent to a degassing treatment in order to suppress oxidation of the nanoparticles 2. Alternatively, it is preferable to use a super-dehydrated-grade organic solvent having a moisture amount of 10 ppm or less as the washing solvent. Note that a magnet may be used to collect the nanoparticles 2. The metal magnetic powder 1 is obtained through the above steps.

Note that a series of steps from weighing of the raw materials to washing and collection of the nanoparticles is performed in the inert gas atmosphere such as an Ar atmosphere.

### Method for Manufacturing Metal Magnetic Powder 1 by Vapor Phase Thermal Decomposition Method

A thermal decomposition method is a method for producing Co nanoparticles by heating and thermally decomposing a cobalt complex as the precursor. In general, the precursor is added to a solvent such as dichlorobenzene or ethylene glycol, and a reaction solution is heated to a high temperature of about 180° C. to thermally decompose the precursor in a liquid phase (i.e., a liquid phase thermal decomposition method). In the present embodiment, it is preferable to thermally decompose the precursor in a vapor phase of an inert atmosphere without using a solvent (i.e., a vapor phase thermal decomposition method). A main phase of nanoparticles is likely to be fcc-Co or ϵ-Co in the related-art liquid phase thermal decomposition method, whereas the nanoparticles 2 whose main phase is hcp-Co can be obtained in the vapor phase thermal decomposition method.

In the vapor phase thermal decomposition method, it is preferable to use octacarbonyldicobalt (Co₂(CO)₈) or Co₄(CO)₁₂ as the precursor. The precursor and the additive including the amphoteric metal are weighed such that the metal magnetic powder 1 has a desired composition, and the weighed raw materials are put into a reaction vessel such as a separable flask. Then, the reaction vessel is placed in an oil bath, and the reaction vessel is heated in an inert atmosphere such as an Ar atmosphere to thermally decompose the precursor. At this time, the raw materials in the reaction vessel are stirred using a mechanical stirrer or the like. In addition, a surfactant such as oleic acid or a silane coupling agent may be added during the thermal decomposition reaction. As the silane coupling agent, for example, a silane coupling agent containing an aniline structure and/or a phenyl group is preferably used, and N-phenyl-3-aminopropyltrimethoxysilane is more preferably used.

A reaction temperature (that is, a heating temperature of the raw materials) in the vapor phase thermal decomposition method is preferably 52° C. or higher and 180° C. or lower, more preferably 57° C. or higher and 120° C. or lower, and even more preferably 57° C. or higher and 80° C. or lower. As the reaction temperature is raised, a mean particle size of the nanoparticles 2 tends to increase. When the reaction temperature is low, the mean particle size of the nanoparticles 2 decreases, and a ratio of hcp-Co tends to increase.

It is desirable to appropriately adjust a reaction time in the vapor phase thermal decomposition method according to the reaction temperature. For example, the reaction time is preferably 0.01 h to 3.5 h when the reaction temperature is 150° C. to 180° C., the reaction time is preferably 0.1 h to 10 h when the reaction temperature is 100° C. or higher and lower than 150° C. When the reaction temperature is lower than 100° C., the reaction time is preferably 0.25 h to 96 h, and more preferably 1 h to 50 h. As the reaction time is increased, the mean particle size of the nanoparticles 2 tends to increase.

The crystal structure of the nanoparticles 2 can be controlled by a type of surfactant, the reaction temperature, and the like. For example, in the case where no surfactant is added, fcc-Co is more likely to be produced as the sub-phase when the reaction temperature is raised. In a case where oleic acid is added as the surfactant, ϵ-Co is likely to be produced as the sub-phase, and a ratio of ϵ-Co tends to increase when the reaction temperature is raised. On the other hand, in a case where N-phenyl-3-aminopropyltrimethoxysilane as the silane coupling agent is added as the surfactant, both fcc-Co and ϵ-Co are likely to be obtained as the sub-phases, and a ratio of the sub-phases increases when the reaction temperature is raised.

In the vapor phase thermal decomposition method, the additive including the amphoteric metal may be added at the start of the reaction, or may be added after a lapse of a predetermined time from the start of the reaction. When the additive is added at the start of the reaction, the amphoteric metal is likely to be present inside the nanoparticles 2. As the timing of adding the additive is delayed, the amphoteric metal is more likely to adhere to the surfaces of the nanoparticles 2.

After the thermal decomposition reaction is continued for a desired time, the reaction vessel is removed from the oil bath and naturally cooled until a product reaches a room temperature. After the cooling, the produced nanoparticles 2 are washed using a washing solvent and collected. As the washing solvent, for example, acetone, dichlorobenzene, or ethanol can be used, and it is preferable to subject the washing solvent to a degassing treatment in order to suppress oxidation of the nanoparticles 2. Alternatively, it is preferable to use a super-dehydrated-grade organic solvent having a moisture amount of 10 ppm or less as the washing solvent. Note that a magnet may be used to collect the nanoparticles 2. The metal magnetic powder 1 is obtained through the above steps.

In the case where the metal magnetic powder 1 is manufactured by the vapor phase thermal decomposition method, a series of steps from weighing of the raw materials to washing and collection is performed in an inert gas atmosphere such as an Ar atmosphere, which is similar to the liquid phase thermal decomposition accompanied by the disproportionation reaction.

### Method for Manufacturing Composite Magnetic Body 10

Next, an example of the method for manufacturing the composite magnetic body 10 is described.

The composite magnetic body 10 can be manufactured by mixing the metal magnetic powder 1 manufactured by the liquid phase thermal decomposition accompanied by the disproportionation reaction or the vapor phase thermal decomposition, the resin 6, and a solvent, and performing a predetermined dispersion treatment. As the dispersion treatment, it is preferable to adopt an ultrasonic dispersion treatment or a media dispersion treatment such as a beads mill. Conditions for the dispersion treatment are not particularly limited, and various conditions may be set such that the nanoparticles 2 are uniformly dispersed in the resin 6. As the solvent to be added in the dispersion treatment, for example, an organic solvent such as acetone, dichlorobenzene, or ethanol can be used, and it is preferable to use a degassed organic solvent or a super-dehydrated-grade organic solvent. In addition, various ceramic beads can be used as a medium used in the media dispersion treatment, and it is preferable to use beads of ZrO₂ having a large specific gravity among the ceramic beads.

Note that the existing locations of the amphoteric metal in the composite magnetic body 10 may be changed by the dispersion treatment. For example, the amphoteric metal adhering to the surfaces of the nanoparticles 2 is hardly peeled off when an ultrasonic dispersion treatment is performed, but the amphoteric metal adhering to the surfaces of the nanoparticles 2 is likely to be peeled off when the media dispersion treatment is performed. Therefore, a proportion of the amphoteric metal dispersed in the resin 6 tends to increase as a treatment time of the media dispersion is increased.

Slurry obtained by the above-described dispersion treatment is dried in an Ar atmosphere to obtain a dried material in which the solvent has been volatilized. Thereafter, the dried material is subjected to griding using a mortar, a dry grinder, or the like to obtain granules containing the metal magnetic powder 1 and the resin 6. Then, the granules were charged into a press mold and pressed to obtain the composite magnetic body 10. When a thermosetting resin is used as the resin 6, it is preferable to perform a curing treatment after pressure-mold. The method for manufacturing the composite magnetic body 10 is not limited to the above-described pressure-mold method. For example, the slurry obtained by the dispersion treatment may be applied onto a PET film and dried to obtain sheet-like composite magnetic body 10.

Note that a series of steps for obtaining the composite magnetic body 10 is also performed in an inert atmosphere, such as an Ar atmosphere, similarly to the manufacturing of the metal magnetic powder 1.

### Summary of Embodiment

The metal magnetic powder 1 of the present embodiment includes the nanoparticles 2 having hcp-Co as the main phase and having the mean particle size (D50) of 1 nm to 100 nm. The metal magnetic powder 1 includes at least one amphoteric metal (preferably Zn). Since the amphoteric metal is added to the metal magnetic powder 1 including the nanoparticles 2 of hcp-Co, a magnetic loss can be reduced while ensuring a high permeability in a high frequency band of 1 GHz or higher. In addition, the composite magnetic body 10 also contains the metal magnetic powder 1 having the above characteristics, and thus, it is possible to suitably achieve both the high permeability and the low magnetic loss in the high frequency band.

In the metal magnetic powder 1 and the composite magnetic body 10, W_{AM}/(W_{Co}+W_{AM}) is 0.001% or more and 10% or less. When the ratio of the amphoteric metal satisfies the above requirement, it is possible to more suitably achieve both the high permeability and the low magnetic loss in the high frequency band.

In addition, the metal magnetic powder 1 and the composite magnetic body 10 include fcc-Co and/or ϵ-Co as a sub-phase. Since the sub-phase is included with hcp-Co, it is possible to more suitably achieve both the high permeability and the low magnetic loss in the high frequency band.

Both the metal magnetic powder 1 and the composite magnetic body 10 can be applied to various electronic components such as an inductor, a transformer, a choke coil, a filter, and an antenna, and particularly, can be suitably applied to an electronic component for a high-frequency circuit having an operation frequency of 1 GHz or higher (more preferably 1 GHz to 10 GHz).

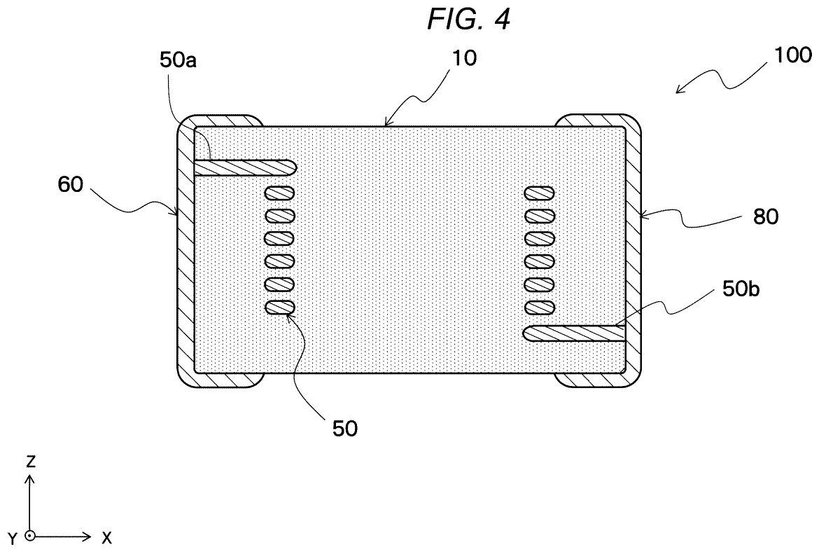

Examples of the electronic component containing the metal magnetic powder 1 (or the composite magnetic body 10) include an inductor 100 as shown in FIG. 4. The inductor 100 has an element body configured using the composite magnetic body 10 of the present embodiment, and a coil portion 50 is embedded in the element body. A pair of external electrodes 60 and 80 is formed on an end surface of the element body, and the external electrodes 60 and 80 are electrically connected to leadout portions 50a and 50b of the coil portion 50, respectively. The electronic component such as the inductor 100 includes the metal magnetic powder 1 (composite magnetic body 10) of the present embodiment, and thus, has excellent high-frequency properties.

Hereinabove, an embodiment of the present disclosure is described, but the present disclosure is not limited to the above-described embodiment, and various modifications can be made within a scope not departing from the gist of the present disclosure.

### EXAMPLES

Hereinafter, the present disclosure is described in further detail based on specific examples, but is not limited to the following examples.

### Experiment 1

In Experiment 1, metal magnetic powders according to Examples E1 to E5 were manufactured by liquid phase thermal decomposition accompanied by a disproportionation reaction. First, CoCl(Ph₃P)₃ as a precursor and ZnCl₂ as an additive including an amphoteric metal were prepared as raw materials, and these raw materials were weighted so that a content ratio of the amphoteric metal (W_{AM}/(W_{Co}+W_{AM})) in the metal magnetic powder after manufacturing was 7%. Then, the raw materials and ethanol as solvent were put into a separable flask to obtain a reaction solution. The reaction solution was stirred for a predetermined time using a mechanical stirrer under Ar atmosphere at room temperature (25° C.). A reaction time in each of Examples was set to a value shown in Table 1.

After stirring of the reaction solution was stopped, produced nanoparticles were washed using super dehydrated acetone and collected by a magnet. The metal magnetic powder according to each of Examples was obtained by the above steps. Note that a series of steps from weighing of raw materials to the washing and collection were performed under the Ar atmosphere.

Next, a composite magnetic body was manufactured using the metal magnetic powder. The method for manufacturing the composite magnetic body was similar for Examples E1 to E5.

First, the metal magnetic powder was weighed so that a content ratio of nanoparticles in the composite magnetic body was 10 vol %. Then, the weighed metal magnetic powder, epoxy resin, and acetone as solvent were mixed together, and the mixture was subjected to an ultrasonic dispersion treatment. A treatment time of the ultrasonic dispersion was set to 10 min, and a dispersion liquid obtained by the ultrasonic dispersion treatment was dried in an Ar atmosphere at 50° C. to obtain a dried material. Then, the dried material was ground in a mortar, and then, the obtained granules were charged into a press mold and pressed to obtain the composite magnetic body. The composite magnetic body in each of the Examples had a toroidal shape having an outer diameter of 7 mm, an inner diameter of 3 mm, and a thickness of 1 mm. A series of steps for manufacturing the composite magnetic body was performed under the Ar atmosphere.

### Comparative Examples A1 to A6

In each of Comparative Examples A1 to A6, a metal magnetic powder was manufactured by liquid phase thermal decomposition accompanied by a disproportionation reaction without using the additive including the amphoteric metal. A reaction time in each of Comparative Examples A1 to A6 was set to a value shown in Table 1. The metal magnetic powders and composite magnetic bodies according to Comparative Examples A1 to A6 were manufactured under the similar manufacturing conditions as those in Examples E1 to E5 except for the above.

Comparative Example B1

In Comparative Example B1, a reaction time was set to 100 h, which is longer than that in Examples E1 to E5. A metal magnetic powder and composite magnetic body according to Comparative Example B1 were manufactured under the similar manufacturing conditions as those in Examples E1 to E5 except for the reaction time.

### Comparative Examples C1 to C4

In each of Comparative Examples C1 to C4, a metal magnetic powder was manufactured by a liquid phase thermal decomposition method. First, Co₂(CO)₈ as a precursor, ZnCl₂ as an additive including an amphoteric metal, and oleic acid as a surfactant were prepared as raw materials, and these raw materials were weighed so that W_{AM}/(W_{Co}+W_{AM}) was 7%. Then, the raw materials and dichlorobenzene as solvent were put into a separable flask to obtain a reaction solution. The separable flask was placed in an oil bath and heated to 180° C., and the reaction solution was stirred with a mechanical stirrer. That is, Co nanoparticles were manufactured by thermally decomposing Co₂(CO)₈ in dichlorobenzene heated to 180° C. A reaction time in each of Comparative Examples C1 to C4 was set to a value shown in Table 1.

After the thermal decomposition reaction was continued for a predetermined time, the separable flask was allowed to stand at room temperature, and produced nanoparticles were naturally cooled to the room temperature. After the cooling, the nanoparticles were washed using super dehydrated acetone and collected by magnet. The metal magnetic powders according to Comparative Examples C1 to C4 were obtained by the above steps. Note that a series of steps from weighing of raw materials to the washing and collected were performed under the Ar atmosphere. In addition, composite magnetic body according to each of Comparative Examples C1 to C4 was obtained under the similar conditions as those in Examples E1 to E5.

### Comparative Examples D1 and D2

In Comparative Example D1 and Comparative Example D2, when metal magnetic powder was manufactured by a liquid phase thermal decomposition method, Co₂(CO)₈ was used as the precursor, ethylene glycol was used as solvent, and polyvinylpyrrolidone (Poly(N-vinyl-2-pyrrolidone)) was used as surfactant. No amphoteric metal was added in Comparative Example D1, and ZnCl2 was added in Comparative Example D2. In Comparative Examples D1 and D2, reaction temperature was set to 170° C., and reaction time was set to 3 h. The metal magnetic powder and composite magnetic body according to each of Comparative Examples D1 and D2 were obtained under the similar manufacturing conditions as those in Comparative Examples C1 to C4 except for the above.

The following evaluations were performed for each of Examples and each of Comparative Examples in Experiment 1.

### Mean Particle Diameter of Nanoparticles

The nanoparticles manufactured in each of Examples and each of Comparative Examples were observed with a TEM (JEM-2100 F manufactured by JEOL Ltd.) at a magnification of 500,000 times. Then, equivalent circular diameters of 500 nanoparticles were measured using image analysis software to calculate a mean particle size (D50) thereof.

### Composition Analysis of Metal Magnetic Powder

A sample for composition analysis was collected from the composite magnetic body in a glove box, and a content of Co (wt %) and a content of the amphoteric metal (wt %) in the sample were measured by ICP-AES (ICPS-8100CL manufactured by Shimadzu Corporation). Then, the content ratio of the amphoteric metal (W_{AM}/(W_{Co}+W_{AM})) was calculated from measurement results.

### Analysis of Crystal Structure

An XRD pattern of the composite magnetic body was obtained by 2θ/θ measurement using an XRD device (Smart Lab manufactured by Rigaku Corporation). Then, the obtained XRD pattern was analyzed by X-ray analysis integrated software (SmartLab Studio II) to calculate proportions of hcp-Co, fcc-Co, and ϵ-Co (W_{hcp}, W_{fcc}, and W_{ϵ}). In addition, a main phase of the metal magnetic powder (nanoparticles) was identified on the basis of the calculation results of W_{hcp}, W_{fcc}, and W_{ϵ} and a ratio of hcp-Co ((W_{hcp}/(W_{hcp}+W_{fcc}+W_{ϵ})) was calculated.

### Evaluation of Magnetic Properties

A real part (that is, a permeability μ′ (no unit)) and an imaginary part μ″ of a complex permeability at 5 GHz were measured by a coaxial S-parameter method using a network analyzer (HP8753D manufactured by Agilent Technologies, Inc.). Then, a magnetic loss tanδ (no unit) at 5 GHz was calculated as μ″/μ′. The permeability μ′ and the magnetic loss tanδ also vary depending on the content ratio of nanoparticles in the composite magnetic body. When the content ratio of nanoparticles in the composite magnetic body was 10 vol % as in each sample of Experiment 1, a sample having the permeability μ′ of 1.05 or more and the magnetic loss tanδ of 0.08 or less was determined as “good”.

Evaluation results of Examples and Comparative Examples in Experiment 1 are shown in Table 1.

TABLE 1

| | Powder manufacturing conditions | | | | | |
|---|---|---|---|---|---|---|
| | | | | | Reaction | Reaction |
| Sample | Manufacturing | | | | temperature | time |
| No. | method | Precursor | Solvent | Additive | (° C.) | (h) |
| Comp. Ex. A1 | Disproportionation | CoCl(Ph₃P)₃ | Ethanol | — | 25 | 0.1 |
| Comp. Ex. A2 | Disproportionation | CoCl(Ph₃P)₃ | Ethanol | — | 25 | 0.5 |
| Comp. Ex. A3 | Disproportionation | CoCl(Ph₃P)₃ | Ethanol | — | 25 | 1 |
| Comp. Ex. A4 | Disproportionation | CoCl(Ph₃P)₃ | Ethanol | — | 25 | 10 |
| Comp. Ex. A5 | Disproportionation | CoCl(Ph₃P)₃ | Ethanol | — | 25 | 72 |
| Comp. Ex. A6 | Disproportionation | CoCl(Ph₃P)₃ | Ethanol | — | 25 | 100 |
| Ex. E1 | Disproportionation | CoCl(Ph₃P)₃ | Ethanol | ZnCl₂ | 25 | 0.1 |
| Ex. E2 | Disproportionation | CoCl(Ph₃P)₃ | Ethanol | ZnCl₂ | 25 | 0.5 |
| Ex. E3 | Disproportionation | CoCl(Ph₃P)₃ | Ethanol | ZnCl₂ | 25 | 1 |
| Ex. E4 | Disproportionation | CoCl(Ph₃P)₃ | Ethanol | ZnCl₂ | 25 | 10 |
| Ex. E5 | Disproportionation | CoCl(Ph₃P)₃ | Ethanol | ZnCl₂ | 25 | 72 |
| Comp. Ex. B1 | Disproportionation | CoCl(Ph₃P)₃ | Ethanol | ZnCl₂ | 25 | 100 |
| Comp. Ex. C1 | Liquid phase thermal | Co₂(CO)₈ | Dichlorobenzene | Oleic acid | 180 | 0.01 |
| | decomposition | | | ZnCl₂ | | |
| Comp. Ex. C2 | Liquid phase thermal | Co₂(CO)₈ | Dichlorobenzene | Oleic acid | 180 | 1 |
| | decomposition | | | ZnCl₂ | | |
| Comp. Ex. C3 | Liquid phase thermal | Co₂(CO)₈ | Dichlorobenzene | Oleic acid | 180 | 2 |
| | decomposition | | | ZnCl₂ | | |
| Comp. Ex. C4 | Liquid phase thermal | Co₂(CO)₈ | Dichlorobenzene | Oleic acid | 180 | 3 |
| | decomposition | | | ZnCl₂ | | |
| Comp. Ex. D1 | Liquid phase thermal | Co₂(CO)₈ | Ethylene glycol | PVP | 170 | 3 |
| | decomposition | | | | | |
| Comp. Ex. D2 | Liquid phase thermal | Co₂(CO)₈ | Ethylene glycol | PVP | 170 | 3 |
| | decomposition | | | ZnCl₂ | | |

| | Metal magnetic powder | | | | | |
|---|---|---|---|---|---|---|
| | | | Amphoteric metal | | Magnetic properties | |
| | Nanoparticles | | | Content ratio | Permeability | Magnetic loss |
| Sample | D50 | Main | | W_{AM}/(W_{Co} + W_{AM}) | μ′ | tanδ |
| No. | (nm) | phase | Type | (%) | at 5 GHz | at 5 GHz |
| Comp. Ex. A1 | 2 | hcp-Co | — | 0 | 1.23 | 0.086 |
| Comp. Ex. A2 | 8 | hcp-Co | — | 0 | 1.23 | 0.086 |
| Comp. Ex. A3 | 21 | hcp-Co | — | 0 | 1.24 | 0.087 |
| Comp. Ex. A4 | 51 | hcp-Co | — | 0 | 1.24 | 0.092 |
| Comp. Ex. A5 | 102 | hcp-Co | — | 0 | 1.25 | 0.098 |
| Comp. Ex. A6 | 122 | hcp-Co | — | 0 | 1.13 | 0.122 |
| Ex. E1 | 1 | hcp-Co | Zn | 7 | 1.14 | 0.067 |
| Ex. E2 | 8 | hcp-Co | Zn | 7 | 1.15 | 0.068 |
| Ex. E3 | 19 | hcp-Co | Zn | 7 | 1.15 | 0.068 |
| Ex. E4 | 50 | hcp-Co | Zn | 7 | 1.16 | 0.069 |
| Ex. E5 | 100 | hcp-Co | Zn | 7 | 1.16 | 0.073 |
| Comp. Ex. B1 | 120 | hcp-Co | Zn | 7 | 1.14 | 0.113 |
| Comp. Ex. C1 | 2 | ε-Co | Zn | 7 | 1.28 | 0.101 |
| Comp. Ex. C2 | 19 | ε-Co | Zn | 7 | 1.28 | 0.101 |
| Comp. Ex. C3 | 50 | ε-Co | Zn | 7 | 1.30 | 0.103 |
| Comp. Ex. C4 | 69 | ε-Co | Zn | 7 | 1.30 | 0.105 |
| Comp. Ex. D1 | 45 | fcc-Co | — | — | 1.27 | 0.115 |
| Comp. Ex. D2 | 43 | fcc-Co | Zn | 7 | 1.24 | 0.106 |

As shown in Table 1, in each of Comparative Examples A1 to A6, Co nanoparticles having hcp-Co as the main phase were obtained by the liquid phase thermal decomposition accompanied by the disproportionation reaction, but the amphoteric metal (Zn) was not contained in the manufactured metal magnetic powder and composite magnetic body since ZnCl₂ was not added during the reaction. In these Comparative Examples A1 to A6, a high permeability was obtained, but a magnetic loss was high, and evaluation criteria of magnetic properties were not satisfied.

In Comparative Examples C1 to C4 manufactured by the related-art liquid phase thermal decomposition method, the main phase was not hcp-Co but ϵ-Co. In these Comparative Examples C1 to C4, Zn was added as the amphoteric metal, but a magnetic loss was as high as 0.1 or more, and the evaluation criteria of magnetic properties were not satisfied. In addition, in Comparative Examples D1 and D2 having fcc-Co as the main phase as well, a magnetic loss was high, and the evaluation criteria of the magnetic properties were not satisfied.

In Examples E1 to E5, it has been confirmed that the nanoparticles having hcp-Co as the main phase were obtained and Zn was contained as the amphoteric metal in the composite magnetic body (that is, in the metal magnetic powder). In each of the XRD patterns of Examples E1 to E5, diffraction peaks of Zn were detected, and it has been confirmed that Zn is present as metal crystals. Further, it was possible to reduce the magnetic loss at 5 GHz in Examples El to E5, as compared with each of Comparative Examples while ensuring a high permeability μ′.

In Comparative Example B1 as well, the main phase of the nanoparticles was hcp-Co, and Zn was contained in the composite magnetic body, which is similar to Examples E1 to E5. In Comparative Example B1, however, a mean particle size (D50) of the nanoparticles exceeded 100 nm, and a magnetic loss was increased as compared with Examples E1 to E5.

From the results shown in Table 1, it has been found that both a high permeability and a low magnetic loss can be suitably achieved in a high frequency band by adding Zn to the metal magnetic powder having a mean particle size (D50) of 1 nm to 100 nm and having hcp-Co as the main phase.

### Experiment 2

In Experiment 2, a metal magnetic powder was manufactured under the same conditions as those in Example E3 in Experiment 1, and then, the metal magnetic powder was subjected to a gradual oxidation treatment to obtain metal magnetic powders according to Examples E3α and E3β. Conditions for the gradual oxidation treatment were controlled to make a content rate of Co (W_{Co}) relative to 100 wt % of the metal magnetic powder have a value shown in Table 2. Since part of Co included in the metal magnetic powder was oxidized by the gradual oxidation treatment, the metal magnetic powders in Examples E3α and E3β included oxygen (O) in addition to Co (main component) and Zn (amphoteric metal).

In Examples E3α and E3β in Experiment 2, a composite magnetic body was manufactured under the similar conditions as those in Example E3, and the same evaluations as those in Experiment 1 were performed. Evaluation results of Experiment 2 are shown in Table 2 (Table 2 also shows the results of Example E3 in Experiment 1). Note that the content rate of Co shown in Table 2 was calculated by analyzing an XRD pattern of the composite magnetic body with X-ray analysis integrated software, in each of Examples.

TABLE 2

| | | | | | | Metal magnetic powder | | | | | | |
|---|---|---|---|---|---|---|---|---|---|---|---|---|
| | | | | | | | | | Amphoteric | | Magnetic properties | |
| | Powder manufacturing conditions | | | | | | | Content | metal | | | Magnetic |
| | | | | Reaction | Reaction | Nanoparticles | | rate | | Content | Permeability | loss |
| Sample | | | | temperature | time | D50 | Main | of Co | | ratio | μ′ | tanδ |
| No. | Precursor | Solvent | Additive | (° C.) | (h) | (nm) | phase | (wt %) | Type | (%) | at 5 GHz | at 5 GHz |
| Ex. E3α | CoCl(Ph₃P)₃ | Ethanol | ZnCl₂ | 25 | 1 | 19 | hcp-Co | 80 | Zn | 7 | 1.08 | 0.063 |
| Ex. E3β | CoCl(Ph₃P)₃ | Ethanol | ZnCl₂ | 25 | 1 | 19 | hcp-Co | 90 | Zn | 7 | 1.13 | 0.066 |
| Ex. E3 | CoCl(Ph₃P)₃ | Ethanol | ZnCl₂ | 25 | 1 | 19 | hep-Co | 93 | Zn | 7 | 1.15 | 0.068 |

As shown in Table 2, the same effects as those of Example E3 could also be confirmed in Examples E3α and E3β in which the content rate of Co was changed by the gradual oxidation treatment, and a magnetic loss could be reduced at 5 GHz as compared with the related art (Comparative Examples) while ensuring a high permeability. In the XRD patterns of Examples E3α and E3β as well, diffraction peaks of Zn were detected, and it has been confirmed that Zn is present as metal crystals, which is similar to Example E3.

### Experiment 3

In Experiment 3, metal magnetic powders and composite magnetic bodies were manufactured under conditions shown in Table 3 by changing a type of an amphoteric metal to be added. Specifically, as an additive, AlCl₃ was used in Examples F1 to F5, SnCl₂ was used in Examples G1 to G5, and PbCl₂ was used in Examples H1 to H5. In all of Examples in Experiment 3, the metal magnetic powders were manufactured by liquid phase thermal decomposition accompanied by a disproportionation reaction using CoCl(Ph₃P)₃ as the precursor and ethanol as solvent. Manufacturing conditions were the similar as those of Examples E1 to E5 except that a type of the additive was changed.

### Comparative Examples B2 to B4

As an additive, AlCl₃ was used in Comparative Example B2, SnCl2 was used in Comparative Example B3, and PbCl₂ was used in Comparative Example B4. In Comparative Examples B2 to B4 as well, the metal magnetic powders were manufactured by liquid phase thermal decomposition accompanied by a disproportionation reaction using CoCl(Ph₃P)₃ as the precursor and ethanol as solvent. The metal magnetic powders and the composite magnetic bodies according to Comparative Examples B2 to B4 were manufactured in the similar manner as in Comparative Example B1 except that a type of the additive was changed.

Evaluation results of Examples and Comparative Examples in Experiment 3 are shown in Table 3. Note that Table 3 also shows the results of Examples E1 to E5 and Comparative Example B1 in Experiment 1.

TABLE 3

| | Powder manufacturing conditions | | | Metal magnetic powder | | | | Magnetic properties | |
|---|---|---|---|---|---|---|---|---|---|
| | | Reaction | Reaction | Nanoparticles | | Amphoteric metal | | Permeability | Magnetic loss |
| Sample | | temperature | time | D50 | Main | | Content ratio | μ′ | tanδ |
| No. | Additive | (° C.) | (h) | (nm) | phase | Type | (%) | at 5 GHz | at 5 GHz |
| Ex. E1 | ZnCl₂ | 25 | 0.1 | 1 | hcp-Co | Zn | 7 | 1.14 | 0.067 |
| Ex. E2 | ZnCl₂ | 25 | 0.5 | 8 | hcp-Co | Zn | 7 | 1.15 | 0.068 |
| Ex. E3 | ZnCl₂ | 25 | 1 | 19 | hcp-Co | Zn | 7 | 1.15 | 0.068 |
| Ex. E4 | ZnCl₂ | 25 | 10 | 50 | hcp-Co | Zn | 7 | 1.16 | 0.069 |
| Ex. E5 | ZnCl₂ | 25 | 72 | 100 | hcp-Co | Zn | 7 | 1.16 | 0.073 |
| Comp. Ex. B1 | ZnCl₂ | 25 | 100 | 120 | hcp-Co | Zn | 7 | 1.14 | 0.113 |
| Ex. F1 | AlCl₃ | 25 | 0.1 | 1 | hcp-Co | Al | 7 | 1.16 | 0.072 |
| Ex. F2 | AlCl₃ | 25 | 0.5 | 8 | hcp-Co | Al | 7 | 1.17 | 0.072 |
| Ex. F3 | AlCl₃ | 25 | 1 | 19 | hcp-Co | Al | 7 | 1.17 | 0.070 |
| Ex. F4 | AlCl₃ | 25 | 10 | 48 | hcp-Co | Al | 7 | 1.17 | 0.071 |
| Ex. F5 | AlCl₃ | 25 | 72 | 100 | hcp-Co | Al | 7 | 1.19 | 0.078 |
| Comp. Ex. B2 | AlCl₃ | 25 | 100 | 122 | hcp-Co | Al | 7 | 1.10 | 0.115 |
| Ex. G1 | SnCl₂ | 25 | 0.1 | 1 | hcp-Co | Sn | 7 | 1.15 | 0.074 |
| Ex. G2 | SnCl₂ | 25 | 0.5 | 12 | hcp-Co | Sn | 7 | 1.17 | 0.073 |
| Ex. G3 | SnCl₂ | 25 | 1 | 19 | hcp-Co | Sn | 7 | 1.16 | 0.072 |
| Ex. G4 | SnCl₂ | 25 | 10 | 50 | hcp-Co | Sn | 7 | 1.16 | 0.072 |
| Ex. G5 | SnCl₂ | 25 | 72 | 100 | hcp-Co | Sn | 7 | 1.18 | 0.078 |
| Comp. Ex. B3 | SnCl₂ | 25 | 100 | 122 | hcp-Co | Sn | 7 | 1.09 | 0.116 |
| Ex. H1 | PbCl₂ | 25 | 0.1 | 2 | hcp-Co | Pb | 7 | 1.17 | 0.072 |
| Ex. H2 | PbCl₂ | 25 | 0.5 | 11 | hcp-Co | Pb | 7 | 1.17 | 0.073 |
| Ex. H3 | PbCl₂ | 25 | 1 | 22 | hcp-Co | Pb | 7 | 1.17 | 0.071 |
| Ex. H4 | PbCl₂ | 25 | 10 | 48 | hcp-Co | Pb | 7 | 1.16 | 0.073 |
| Ex. H5 | PbCl₂ | 25 | 72 | 99 | hcp-Co | Pb | 7 | 1.17 | 0.078 |
| Comp. Ex. B4 | PbCl₂ | 25 | 100 | 122 | hcp-Co | Pb | 7 | 1.10 | 0.115 |

As shown in Table 3, the same effects as those of Examples E1 to E5 could be confirmed in Examples F1 to F5, G1 to G5, and H1 to H5 in which the amphoteric metals other than Zn were added. That is, even when Al, Sn, or Pb was added instead of Zn, both a high permeability and a low magnetic loss could be achieved at 5 GHz. In each of Examples in Experiment 3 as well, diffraction peaks of the amphoteric metal (Al, Sn, or Pb) could be confirmed by an XRD pattern, and it has been found that the amphoteric metal is present as metal crystals, which is similar to Examples E1 to E5.

In addition, the magnetic loss was the lowest in Examples E1 to E5 in which Zn was added among Examples shown in Table 3, and it has been found that it is preferable to add Zn particularly as the amphoteric metal.

### Experiment 4

In each of Examples and each of Comparative Examples in Experiment 4, a metal magnetic powder was manufactured by adjusting a compounding ratio of the additive containing the amphoteric metal to make a content ratio of the amphoteric metal (W_{AM}/(W_{Co}+W_{AM})) have values shown in Tables 4 and 5. Note that the metal magnetic powder was manufactured in each of Examples and each of Comparative Examples in Experiment 4 by liquid phase thermal decomposition accompanied by a disproportionation reaction using CoCl(Ph₃P)₃ as the precursor and ethanol as solvent, and the reaction temperature and the reaction time were set to values shown in Tables 4 and 5. In particular, in each of Examples shown in Table 5, the reaction temperature was set to room temperature (25° C.) and the reaction time was set to 1 h so that the mean particle size (D50) of the nanoparticles was in a range of 20±2 nm.

Manufacturing conditions other than the above in Experiment 4 were similar as those in Experiment 1, and magnetic properties of composite magnetic bodies according to Examples and Comparative Examples were evaluated. Evaluation results of Experiment 4 are shown in Tables 4 and 5.

TABLE 4

| | Powder manufacturing conditions | | | Metal magnetic powder | | | | Magnetic properties | |
|---|---|---|---|---|---|---|---|---|---|
| | | Reaction | Reaction | Nanoparticles | | Amphoteric metal | | Permeability | Magnetic loss |
| Sample | | temperature | time | D50 | Main | | Content ratio | μ′ | tanδ |
| No. | Additive | (° C.) | (h) | (nm) | phase | Type | (%) | at 5 GHz | at 5 GHz |
| Ex. E6 | ZnCl₂ | 25 | 1 | 20 | hcp-Co | Zn | 0.001 | 1.17 | 0.069 |
| Ex. E7 | ZnCl₂ | 25 | 1 | 19 | hcp-Co | Zn | 1 | 1.16 | 0.069 |
| Ex. E8 | ZnCl₂ | 25 | 1 | 22 | hcp-Co | Zn | 3 | 1.16 | 0.069 |
| Ex. E9 | ZnCl₂ | 25 | 1 | 18 | hcp-Co | Zn | 5 | 1.15 | 0.067 |
| Ex. E3 | ZnCl₂ | 25 | 1 | 19 | hcp-Co | Zn | 7 | 1.15 | 0.068 |
| Ex. E10 | ZnCl₂ | 25 | 1 | 22 | hcp-Co | Zn | 10 | 1.14 | 0.067 |
| Ex. E11 | ZnCl₂ | 25 | 0.1 | 2 | hcp-Co | Zn | 1 | 1.15 | 0.069 |
| Ex. E12 | ZnCl₂ | 25 | 0.1 | 1 | hcp-Co | Zn | 3 | 1.15 | 0.068 |
| Ex. E1 | ZnCl₂ | 25 | 0.1 | 1 | hcp-Co | Zn | 7 | 1.14 | 0.067 |
| Ex. E13 | ZnCl₂ | 25 | 0.5 | 8 | hcp-Co | Zn | 1 | 1.18 | 0.071 |
| Ex. E14 | ZnCl₂ | 25 | 0.5 | 10 | hcp-Co | Zn | 3 | 1.16 | 0.070 |
| Ex. E2 | ZnCl₂ | 25 | 0.5 | 8 | hcp-Co | Zn | 7 | 1.15 | 0.068 |
| Ex. E7 | ZnCl₂ | 25 | 1 | 19 | hcp-Co | Zn | 1 | 1.16 | 0.069 |
| Ex. E8 | ZnCl₂ | 25 | 1 | 22 | hcp-Co | Zn | 3 | 1.16 | 0.069 |
| Ex. E3 | ZnCl₂ | 25 | 1 | 19 | hcp-Co | Zn | 7 | 1.15 | 0.068 |
| Ex. E15 | ZnCl₂ | 25 | 10 | 50 | hcp-Co | Zn | 1 | 1.17 | 0.073 |
| Ex. E16 | ZnCl₂ | 25 | 10 | 50 | hcp-Co | Zn | 3 | 1.17 | 0.071 |
| Ex. E4 | ZnCl₂ | 25 | 10 | 50 | hcp-Co | Zn | 7 | 1.16 | 0.069 |
| Ex. E17 | ZnCl₂ | 25 | 72 | 100 | hcp-Co | Zn | 1 | 1.19 | 0.075 |
| Ex. E18 | ZnCl₂ | 25 | 72 | 100 | hcp-Co | Zn | 3 | 1.17 | 0.075 |
| Ex. E5 | ZnCl₂ | 25 | 72 | 100 | hcp-Co | Zn | 7 | 1.16 | 0.073 |
| Comp. Ex. B5 | ZnCl₂ | 25 | 100 | 120 | hcp-Co | Zn | 1 | 1.17 | 0.115 |
| Comp. Ex. B6 | ZnCl₂ | 25 | 100 | 120 | hcp-Co | Zn | 3 | 1.15 | 0.113 |
| Comp. Ex. B1 | ZnCl₂ | 25 | 100 | 120 | hcp-Co | Zn | 7 | 1.14 | 0.113 |

TABLE 5

| | Powder manufacturing conditions | | | Metal magnetic powder | | | | Magnetic properties | |
|---|---|---|---|---|---|---|---|---|---|
| | | Reaction | Reaction | Nanoparticles | | Amphoteric metal | | Permeability | Magnetic loss |
| Sample | | temperature | time | D50 | Main | | Content ratio | μ′ | tanδ |
| No. | Additive | (° C.) | (h) | (nm) | phase | Type | (%) | at 5 GHz | at 5 GHz |
| Ex. E6 | ZnCl₂ | 25 | 1 | 20 | hcp-Co | Zn | 0.001 | 1.17 | 0.069 |
| Ex. E7 | ZnCl₂ | 25 | 1 | 19 | hcp-Co | Zn | 1 | 1.16 | 0.069 |
| Ex. E8 | ZnCl₂ | 25 | 1 | 22 | hcp-Co | Zn | 3 | 1.16 | 0.069 |
| Ex. E9 | ZnCl₂ | 25 | 1 | 18 | hcp-Co | Zn | 5 | 1.15 | 0.067 |
| Ex. E3 | ZnCl₂ | 25 | 1 | 19 | hcp-Co | Zn | 7 | 1.15 | 0.068 |
| Ex. E10 | ZnCl₂ | 25 | 1 | 22 | hcp-Co | Zn | 10 | 1.14 | 0.067 |
| Ex. F6 | AlCl₃ | 25 | 1 | 19 | hcp-Co | Al | 0.001 | 1.17 | 0.069 |
| Ex. F7 | AlCl₃ | 25 | 1 | 19 | hcp-Co | Al | 1 | 1.17 | 0.067 |
| Ex. F8 | AlCl₃ | 25 | 1 | 18 | hcp-Co | Al | 3 | 1.16 | 0.068 |
| Ex. F9 | AlCl₃ | 25 | 1 | 20 | hcp-Co | Al | 5 | 1.16 | 0.069 |
| Ex. F3 | AlCl₃ | 25 | 1 | 19 | hcp-Co | Al | 7 | 1.17 | 0.070 |
| Ex. F10 | AlCl₃ | 25 | 1 | 22 | hcp-Co | Al | 10 | 1.15 | 0.069 |
| Ex. G6 | SnCl₂ | 25 | 1 | 21 | hcp-Co | Sn | 0.001 | 1.18 | 0.071 |
| Ex. G7 | SnCl₂ | 25 | 1 | 22 | hcp-Co | Sn | 1 | 1.17 | 0.072 |
| Ex. G8 | SnCl₂ | 25 | 1 | 21 | hcp-Co | Sn | 3 | 1.17 | 0.071 |
| Ex. G9 | SnCl₂ | 25 | 1 | 20 | hcp-Co | Sn | 5 | 1.16 | 0.070 |
| Ex. G3 | SnCl₂ | 25 | 1 | 18 | hcp-Co | Sn | 7 | 1.16 | 0.072 |
| Ex. G10 | SnCl₂ | 25 | 1 | 18 | hcp-Co | Sn | 10 | 1.14 | 0.072 |
| Ex. H6 | PbCl₂ | 25 | 1 | 20 | hcp-Co | Pb | 0.001 | 1.20 | 0.074 |
| Ex. H7 | PbCl₂ | 25 | 1 | 21 | hcp-Co | Pb | 1 | 1.19 | 0.072 |
| Ex. H8 | PbCl₂ | 25 | 1 | 20 | hcp-Co | Pb | 3 | 1.19 | 0.072 |
| Ex. H9 | PbCl₂ | 25 | 1 | 19 | hcp-Co | Pb | 5 | 1.18 | 0.071 |
| Ex. H3 | PbCl₂ | 25 | 1 | 22 | hcp-Co | Pb | 7 | 1.17 | 0.071 |
| Ex. H10 | PbCl₂ | 25 | 1 | 20 | hcp-Co | Pb | 10 | 1.16 | 0.072 |

From the results shown in Tables 4 and 5, it has been found that W_{AM}/(W_{Co}+W_{AM}) is preferably 0.001% (10 ppm) to 10%. In each of Examples in Experiment 4, it has been confirmed that the amphoteric metal is present as metal crystals.

### Experiment 5

In Experiment 5, metal magnetic powders according to Examples P1 to P8 were manufactured by a vapor phase thermal decomposition method. Conditions for the vapor phase thermal decomposition in each of Examples are shown in Table 6. Specifically, in Experiment 5, Co₂(CO)₈ or CO₄(CO)₁₂ was used as the precursor, and the precursor and a chloride of one amphoteric metal (Zn, Al, Sn, or Pb) were weighed so that W_{AM}/(W_{Co}+W_{AM}) was 7%. Then, weighed raw materials were put into a separable flask, and the raw materials in the flask were stirred while being heated to 100° C. An oil bath was used for heating the separable flask, but the precursor was thermally decomposed in a vapor phase without adding solvent to the inside of the separable flask. The atmosphere at this time was Ar atmosphere, and the reaction time of the thermal decomposition was set to 2 h so that the mean particle size (D50) was in a range of 20±2 nm.

After a lapse of 2 hours from the start of the thermal decomposition reaction, the separable flask was allowed to stand at room temperature, and produced nanoparticles were naturally cooled to the room temperature. After the cooling, the nanoparticles were washed using super dehydrated acetone and collected by magnet. The metal magnetic powder according to each of Examples P1 to P8 was obtained by the above steps. Note that a series of steps from weighing of raw materials to the washing and collection were performed under the Ar atmosphere. In addition, composite magnetic body in each of Examples P1 to P8 was manufactured using the metal magnetic powder obtained above under the similar conditions as those in Example E3 of Experiment 1.

Evaluation results of Examples in Experiment 5 are shown in Table 6.

TABLE 6

| | Powder manufacturing conditions | | | | | |
|---|---|---|---|---|---|---|
| | | | | | Reaction | Reaction |
| Sample | Manufacturing | | | | temperature | time |
| No. | method | Precursor | Solvent | Additive | (° C.) | (h) |
| Ex. E3 | Disproportionation | CoCl(Ph₃P)₃ | Ethanol | ZnCl₂ | 25 | 1 |
| Ex. F3 | Disproportionation | CoCl(Ph₃P)₃ | Ethanol | AlCl₃ | 25 | 1 |
| Ex. G3 | Disproportionation | CoCl(Ph₃P)₃ | Ethanol | SnCl₂ | 25 | 1 |
| Ex. H3 | Disproportionation | CoCl(Ph₃P)₃ | Ethanol | PbCl₂ | 25 | 1 |
| Ex. P1 | Gas phase thermal | Co₂(CO)₈ | — | ZnCl₂ | 100 | 2 |
| | decomposition | | | | | |
| Ex. P2 | Gas phase thermal | Co₂(CO)₈ | — | AlCl₃ | 100 | 2 |
| | decomposition | | | | | |
| Ex. P3 | Gas phase thermal | Co₂(CO)₈ | — | SnCl₂ | 100 | 2 |
| | decomposition | | | | | |
| Ex. P4 | Gas phase thermal | Co₂(CO)₈ | — | PbCl₂ | 100 | 2 |
| | decomposition | | | | | |
| Ex. P5 | Gas phase thermal | Co₄(CO)₁₂ | — | ZnCl₂ | 100 | 2 |
| | decomposition | | | | | |
| Ex. P6 | Gas phase thermal | Co₄(CO)₁₂ | — | AlCl₃ | 100 | 2 |
| | decomposition | | | | | |
| Ex. P7 | Gas phase thermal | Co₄(CO)₁₂ | — | SnCl₂ | 100 | 2 |
| | decomposition | | | | | |
| Ex. P8 | Gas phase thermal | Co₄(CO)₁₂ | — | PbCl₂ | 100 | 2 |
| | decomposition | | | | | |

| | Metal magnetic powder | | | | Magnetic properties | |
|---|---|---|---|---|---|---|
| | Nanoparticles | | Amphoteric metal | | Permeability | Magnetic loss |
| Sample | D50 | Main | | Content ratio | μ′ | tanδ |
| No. | (nm) | phase | Type | (%) | at 5 GHz | at 5 GHz |
| Ex. E3 | 19 | hcp-Co | Zn | 7 | 1.15 | 0.068 |
| Ex. F3 | 19 | hcp-Co | Al | 7 | 1.17 | 0.070 |
| Ex. G3 | 18 | hcp-Co | Sn | 7 | 1.16 | 0.072 |
| Ex. H3 | 22 | hcp-Co | Pb | 7 | 1.17 | 0.071 |
| Ex. P1 | 20 | hcp-Co | Zn | 7 | 1.13 | 0.067 |
| Ex. P2 | 19 | hcp-Co | Al | 7 | 1.15 | 0.071 |
| Ex. P3 | 21 | hcp-Co | Sn | 7 | 1.17 | 0.074 |
| Ex. P4 | 18 | hcp-Co | Pb | 7 | 1.18 | 0.070 |
| Ex. P5 | 19 | hcp-Co | Zn | 7 | 1.17 | 0.066 |
| Ex. P6 | 19 | hcp-Co | Al | 7 | 1.18 | 0.072 |
| Ex. P7 | 18 | hcp-Co | Sn | 7 | 1.17 | 0.070 |
| Ex. P8 | 18 | hcp-Co | Pb | 7 | 1.15 | 0.070 |

As shown in Table 6, the nanoparticles having hcp-Co as the main phase were obtained in each of Examples P1 to P8. In addition, diffraction peaks of the amphoteric metal could be confirmed in XRD pattern of each of Examples P1 to P8, and it has been found that the amphoteric metal is present as metal crystals even when the metal magnetic powder was manufactured by the vapor phase thermal decomposition method similarly to the case of the liquid phase thermal decomposition accompanied by the disproportionation reaction. That is, it has been found that the metal magnetic powder of hcp-Co including the amphoteric metal was obtained even when the metal magnetic powder was manufactured by the vapor phase thermal decomposition method while changing a type of the precursor. In Examples P1 to P8 as well, both a high permeability and a low magnetic loss could be achieved at 5 GHz, which is similar to Examples E3, F3, G3, and H3.

### Experiment 6

In Experiment 6, metal magnetic powders according to Examples shown in Table 7 were manufactured by changing a type of the solvent to be used. Specifically, as the solvent, THF was used in Examples T1 to T4, and oleylamine was used in Examples 01 to 04. In each of Examples in Experiment 6, a chloride shown in Table 7 was used as the additive, and a compounding ratio of the chloride was adjusted so that W_{AM}/(W_{Co}+W_{AM}) was 7%. In addition, the reaction temperature was set to the room temperature (25° C.) and the reaction time was set to 1 h so that the mean particle size (D50) of the nanoparticles was 20±2 nm. Experiment conditions other than the above were similar as those in Example E3 in Experiment 1, and composite magnetic body in each of Examples was manufactured using the metal magnetic powder under the similar conditions as those in Experiment 1.

Evaluation results of Examples in Experiment 6 are shown in Table 7. Table 7 shows a ratio of each Co crystalline phase assuming that a sum of W_{hcp}, W_{fcc}, and W_{ϵ}, represented by integrated intensities, is 100%.

TABLE 7

| | Powder manufacturing conditions | | | | | Metal magnetic |
|---|---|---|---|---|---|---|
| | | | | Reaction | Reaction | powder |
| Sample | | | | temperature | time | D50 |
| No. | Precursor | Solvent | Additive | (° C.) | (h) | (nm) |
| Ex. E3 | CoCl(Ph₃P)₃ | Ethanol | ZnCl₂ | 25 | 1 | 19 |
| Ex. F3 | CoCl(Ph₃P)₃ | Ethanol | AlCl₃ | 25 | 1 | 19 |
| Ex. G3 | CoCl(Ph₃P)₃ | Ethanol | SnCl₂ | 25 | 1 | 18 |
| Ex. H3 | CoCl(Ph₃P)₃ | Ethanol | PbCl₂ | 25 | 1 | 22 |
| Ex. T1 | CoCl(Ph₃P)₃ | THF | ZnCl₂ | 25 | 1 | 20 |
| Ex. T2 | CoCl(Ph₃P)₃ | THF | AlCl₃ | 25 | 1 | 19 |
| Ex. T3 | CoCl(Ph₃P)₃ | THF | SnCl₂ | 25 | 1 | 19 |
| Ex. T4 | CoCl(Ph₃P)₃ | THF | PbCl₂ | 25 | 1 | 22 |
| Ex. O1 | CoCl(Ph₃P)₃ | Oleylamine | ZnCl₂ | 25 | 1 | 18 |
| Ex. O2 | CoCl(Ph₃P)₃ | Oleylamine | AlCl₃ | 25 | 1 | 22 |
| Ex. O3 | CoCl(Ph₃P)₃ | Oleylamine | SnCl₂ | 25 | 1 | 22 |
| Ex. O4 | CoCl(Ph₃P)₃ | Oleylamine | PbCl₂ | 25 | 1 | 18 |

| | Metal magnetic powder | | | | | Magnetic properties | |
|---|---|---|---|---|---|---|---|
| | Ratio of | | | Amphoteric metal | | Permeability | Magnetic loss |
| Sample | Co crystalline phase (%) | | | | Content ratio | μ′ | tanδ |
| No. | hep-Co | fcc-Co | ε-Co | Type | (%) | at 5 GHz | at 5 GHz |
| Ex. E3 | 95 | 5 | 0 | Zn | 7 | 1.15 | 0.068 |
| Ex. F3 | 95 | 5 | 0 | Al | 7 | 1.17 | 0.070 |
| Ex. G3 | 94 | 6 | 0 | Sn | 7 | 1.16 | 0.072 |
| Ex. H3 | 97 | 3 | 0 | Pb | 7 | 1.17 | 0.071 |
| Ex. T1 | 72 | 28 | 0 | Zn | 7 | 1.17 | 0.071 |
| Ex. T2 | 72 | 28 | 0 | Al | 7 | 1.18 | 0.076 |
| Ex. T3 | 68 | 32 | 0 | Sn | 7 | 1.18 | 0.075 |
| Ex. T4 | 71 | 29 | 0 | Pb | 7 | 1.18 | 0.075 |
| Ex. O1 | 71 | 19 | 10 | Zn | 7 | 1.17 | 0.070 |
| Ex. O2 | 70 | 20 | 10 | Al | 7 | 1.18 | 0.074 |
| Ex. O3 | 71 | 19 | 10 | Sn | 7 | 1.18 | 0.075 |
| Ex. O4 | 69 | 20 | 11 | Pb | 7 | 1.18 | 0.076 |

As shown in Table 7, it has been found that a ratio of hcp-Co as the main phase increases when ethanol is used as the solvent in liquid phase thermal decomposition accompanied by a disproportionation reaction. In addition, it has been found that fcc-Co as the sub-phase is more likely to be produced in the case of using THF as the solvent as compared with the case of using ethanol. That is, it has been found that nanoparticles are likely to have a mixed-phase structure including the main phase of hcp-Co and the sub-phase of fcc-Co in the case of using THF as the solvent.

On the other hand, it has been found that the sub-phase is more likely to be produced in the case of using oleylamine as the solvent as compared with the case of using ethanol, and both fcc-Co and ϵ-Co are produced as the sub-phases. That is, it has been found that the nanoparticles are likely to have the mixed-phase structure of three Co crystalline phases in the case of using oleylamine as the solvent.

Note that it has been found that the amphoteric metal was present as the metal crystals in Examples T1 to T4 and Examples O1 to O4 in which the solvent was changed. In addition, it has been confirmed that the nanoparticles of hcp-Co and the nanoparticles of the sub-phase were not present in a mixed manner but the nanoparticles having the mixed-phase structure were included in each of Examples in which the sub-phase was present.

In Examples T1 to T4 and Examples O1 to O4 as well, good magnetic properties were obtained at 5 GHz as in Example in which ethanol was used. In particular, from the results shown in Table 7, it has been found that a magnetic loss in a high frequency band is further reduced as the ratio of hcp-Co as the main phase increases.

### Experiment 7

In Experiment 7, metal magnetic powders according to Examples were manufactured under conditions shown in Tables 8 to 12. Specifically, Table 8 shows results of Examples in which the reaction temperature was changed in the range of 10° C. to 65° C. when ethanol was used as the solvent. Table 9 shows results of Examples in which THF was used as the solvent and the reaction temperature was changed in the range of 10° C. to 65° C., and Table 10 shows results of Examples in which oleylamine was used as the solvent and the reaction temperature was changed in the range of 10° C. to 65° C. Note that a compounding ratio of the additive was adjusted so that the ratio of an amphoteric metal (W_{AM}/(W_{Co}+W_{AM})) was 7% in each of Examples shown in Tables 8 to 10. On the other hand, in each of Examples shown in Tables 11 and 12, the ratio of the amphoteric metal (W_{AM}/(W_{Co}+W_{AM})) was changed, and the compounding ratio of the additive was adjusted to make the ratio have a value shown in the tables. Composite magnetic bodies according to Examples were manufactured under the similar manufacturing conditions as those in Experiment 1 except for conditions shown in Tables 8 to 12.

TABLE 8

| | Powder manufacturing conditions | | | | | Metal magnetic |
|---|---|---|---|---|---|---|
| | | | | Reaction | Reaction | powder |
| Sample | | | | temperature | time | D50 |
| No. | Precursor | Solvent | Additive | (° C.) | (h) | (nm) |
| Ex. E1a | CoCl(Ph₃P)₃ | Ethanol | ZnCl₂ | 10 | 0.2 | 1 |
| Ex. E2a | CoCl(Ph₃P)₃ | Ethanol | ZnCl₂ | 10 | 0.7 | 12 |
| Ex. E3a | CoCl(Ph₃P)₃ | Ethanol | ZnCl₂ | 10 | 5 | 21 |
| Ex. E4a | CoCl(Ph₃P)₃ | Ethanol | ZnCl₂ | 10 | 30 | 49 |
| Ex. E5a | CoCl(Ph₃P)₃ | Ethanol | ZnCl₂ | 10 | 80 | 100 |
| Ex. E1 | CoCl(Ph₃P)₃ | Ethanol | ZnCl₂ | 25 | 0.1 | 1 |
| Ex. E2 | CoCl(Ph₃P)₃ | Ethanol | ZnCl₂ | 25 | 0.5 | 8 |
| Ex. E3 | CoCl(Ph₃P)₃ | Ethanol | ZnCl₂ | 25 | 1 | 19 |
| Ex. E4 | CoCl(Ph₃P)₃ | Ethanol | ZnCl₂ | 25 | 10 | 50 |
| Ex. E5 | CoCl(Ph₃P)₃ | Ethanol | ZnCl₂ | 25 | 72 | 100 |
| Ex. E6a | CoCl(Ph₃P)₃ | Ethanol | ZnCl₂ | 40 | 0.02 | 2 |
| Ex. E7a | CoCl(Ph₃P)₃ | Ethanol | ZnCl₂ | 40 | 0.2 | 10 |
| Ex. E8a | CoCl(Ph₃P)₃ | Ethanol | ZnCl₂ | 40 | 0.45 | 20 |
| Ex. E9a | CoCl(Ph₃P)₃ | Ethanol | ZnCl₂ | 40 | 8 | 48 |
| Ex. E10a | CoCl(Ph₃P)₃ | Ethanol | ZnCl₂ | 40 | 55 | 100 |
| Ex. E11a | CoCl(Ph₃P)₃ | Ethanol | ZnCl₂ | 65 | 0.01 | 2 |
| Ex. E12a | CoCl(Ph₃P)₃ | Ethanol | ZnCl₂ | 65 | 0.1 | 10 |
| Ex. E13a | CoCl(Ph₃P)₃ | Ethanol | ZnCl₂ | 65 | 0.25 | 19 |
| Ex. E14a | CoCl(Ph₃P)₃ | Ethanol | ZnCl₂ | 65 | 3.5 | 52 |
| Ex. E15a | CoCl(Ph₃P)₃ | Ethanol | ZnCl₂ | 65 | 10 | 59 |

| | Metal magnetic powder | | | | | Magnetic properties | |
|---|---|---|---|---|---|---|---|
| | Ratio of | | | Amphoteric metal | | Permeability | Magnetic loss |
| Sample | Co crystalline phase (%) | | | | Content ratio | μ′ | tanδ |
| No. | hcp-Co | fcc-Co | ε-Co | Type | (%) | at 5 GHz | at 5 GHz |
| Ex. E1a | 100 | 0 | 0 | Zn | 7 | 1.06 | 0.069 |
| Ex. E2a | 100 | 0 | 0 | Zn | 7 | 1.07 | 0.068 |
| Ex. E3a | 100 | 0 | 0 | Zn | 7 | 1.08 | 0.068 |
| Ex. E4a | 100 | 0 | 0 | Zn | 7 | 1.08 | 0.071 |
| Ex. E5a | 100 | 0 | 0 | Zn | 7 | 1.10 | 0.074 |
| Ex. E1 | 93 | 7 | 0 | Zn | 7 | 1.14 | 0.067 |
| Ex. E2 | 97 | 3 | 0 | Zn | 7 | 1.15 | 0.068 |
| Ex. E3 | 95 | 5 | 0 | Zn | 7 | 1.15 | 0.068 |
| Ex. E4 | 97 | 3 | 0 | Zn | 7 | 1.16 | 0.069 |
| Ex. E5 | 95 | 5 | 0 | Zn | 7 | 1.16 | 0.073 |
| Ex. E6a | 89 | 11 | 0 | Zn | 7 | 1.16 | 0.068 |
| Ex. E7a | 91 | 9 | 0 | Zn | 7 | 1.16 | 0.068 |
| Ex. E8a | 90 | 10 | 0 | Zn | 7 | 1.17 | 0.069 |
| Ex. E9a | 89 | 11 | 0 | Zn | 7 | 1.17 | 0.070 |
| Ex. E10a | 91 | 9 | 0 | Zn | 7 | 1.17 | 0.074 |
| Ex. E11a | 80 | 20 | 0 | Zn | 7 | 1.16 | 0.069 |
| Ex. E12a | 78 | 22 | 0 | Zn | 7 | 1.17 | 0.069 |
| Ex. E13a | 78 | 22 | 0 | Zn | 7 | 1.18 | 0.070 |
| Ex. E14a | 78 | 22 | 0 | Zn | 7 | 1.17 | 0.071 |
| Ex. E15a | 80 | 20 | 0 | Zn | 7 | 1.17 | 0.075 |

TABLE 9

| | Powder manufacturing conditions | | | | | Metal magnetic |
|---|---|---|---|---|---|---|
| | | | | Reaction | Reaction | powder |
| Sample | | | | temperature | time | D50 |
| No. | Precursor | Solvent | Additive | (° C.) | (h) | (nm) |
| Ex. T1a | CoCl(Ph₃P)₃ | THF | ZnCl₂ | 10 | 0.2 | 1 |
| Ex. T2a | CoCl(Ph₃P)₃ | THF | ZnCl₂ | 10 | 0.7 | 9 |
| Ex. T3a | CoCl(Ph₃P)₃ | THF | ZnCl₂ | 10 | 5 | 21 |
| Ex. T4a | CoCl(Ph₃P)₃ | THF | ZnCl₂ | 10 | 30 | 49 |
| Ex. T5a | CoCl(Ph₃P)₃ | THF | ZnCl₂ | 10 | 80 | 100 |
| Ex. T6a | CoCl(Ph₃P)₃ | THF | ZnCl₂ | 25 | 0.1 | 1 |
| Ex. T7a | CoCl(Ph₃P)₃ | THF | ZnCl₂ | 25 | 0.5 | 9 |
| Ex. T1 | CoCl(Ph₃P)₃ | THF | ZnCl₂ | 25 | 1 | 20 |
| Ex. T8a | CoCl(Ph₃P)₃ | THF | ZnCl₂ | 25 | 10 | 51 |
| Ex. T9a | CoCl(Ph₃P)₃ | THF | ZnCl₂ | 25 | 72 | 98 |
| Ex. T10a | CoCl(Ph₃P)₃ | THF | ZnCl₂ | 40 | 0.02 | 1 |
| Ex. T11a | CoCl(Ph₃P)₃ | THF | ZnCl₂ | 40 | 0.2 | 9 |
| Ex. T12a | CoCl(Ph₃P)₃ | THF | ZnCl₂ | 40 | 0.45 | 21 |
| Ex. T13a | CoCl(Ph₃P)₃ | THF | ZnCl₂ | 40 | 8 | 51 |
| Ex. T14a | CoCl(Ph₃P)₃ | THF | ZnCl₂ | 40 | 55 | 100 |
| Ex. T15a | CoCl(Ph₃P)₃ | THF | ZnCl₂ | 65 | 0.01 | 1 |
| Ex. T16a | CoCl(Ph₃P)₃ | THF | ZnCl₂ | 65 | 0.1 | 10 |
| Ex. T17a | CoCl(Ph₃P)₃ | THF | ZnCl₂ | 65 | 0.25 | 18 |
| Ex. T18a | CoCl(Ph₃P)₃ | THF | ZnCl₂ | 65 | 3.5 | 51 |
| Ex. T19a | CoCl(Ph₃P)₃ | THF | ZnCl₂ | 65 | 10 | 59 |

| | Metal magnetic powder | | | | | Magnetic properties | |
|---|---|---|---|---|---|---|---|
| | Ratio of | | | Amphoteric metal | | Permeability | Magnetic loss |
| Sample | Co crystalline phase (%) | | | | Content ratio | μ′ | tanδ |
| No. | hcp-Co | fcc-Co | ε-Co | Type | (%) | at 5 GHz | at 5 GHz |
| Ex. T1a | 81 | 19 | 0 | Zn | 7 | 1.15 | 0.070 |
| Ex. T2a | 81 | 19 | 0 | Zn | 7 | 1.15 | 0.069 |
| Ex. T3a | 82 | 18 | 0 | Zn | 7 | 1.16 | 0.070 |
| Ex. T4a | 82 | 18 | 0 | Zn | 7 | 1.16 | 0.071 |
| Ex. T5a | 79 | 21 | 0 | Zn | 7 | 1.17 | 0.075 |
| Ex. T6a | 71 | 29 | 0 | Zn | 7 | 1.16 | 0.070 |
| Ex. T7a | 70 | 30 | 0 | Zn | 7 | 1.17 | 0.071 |
| Ex. T1 | 72 | 28 | 0 | Zn | 7 | 1.17 | 0.071 |
| Ex. T8a | 68 | 32 | 0 | Zn | 7 | 1.17 | 0.067 |
| Ex. T9a | 72 | 28 | 0 | Zn | 7 | 1.17 | 0.076 |
| Ex. T10a | 59 | 41 | 0 | Zn | 7 | 1.17 | 0.070 |
| Ex. T11a | 59 | 41 | 0 | Zn | 7 | 1.17 | 0.072 |
| Ex. T12a | 61 | 39 | 0 | Zn | 7 | 1.18 | 0.071 |
| Ex. T13a | 62 | 38 | 0 | Zn | 7 | 1.18 | 0.073 |
| Ex. T14a | 60 | 40 | 0 | Zn | 7 | 1.18 | 0.076 |
| Ex. T15a | 52 | 48 | 0 | Zn | 7 | 1.20 | 0.071 |
| Ex. T16a | 50 | 50 | 0 | Zn | 7 | 1.20 | 0.073 |
| Ex. T17a | 51 | 49 | 0 | Zn | 7 | 1.21 | 0.072 |
| Ex. T18a | 52 | 48 | 0 | Zn | 7 | 1.20 | 0.075 |
| Ex. T19a | 51 | 49 | 0 | Zn | 7 | 1.20 | 0.079 |

TABLE 10

| | Powder manufacturing conditions | | | | | Metal magnetic |
|---|---|---|---|---|---|---|
| | | | | Reaction | Reaction | powder |
| Sample | | | | temperature | time | D50 |
| No. | Precursor | Solvent | Additive | (° C.) | (h) | (nm) |
| Ex. O1a | CoCl(Ph₃P)₃ | Olyelamine | ZnCl₂ | 10 | 0.2 | 1 |
| Ex. O2a | CoCl(Ph₃P)₃ | Olyelamine | ZnCl₂ | 10 | 0.7 | 10 |
| Ex. O3a | CoCl(Ph₃P)₃ | Olyelamine | ZnCl₂ | 10 | 5 | 21 |
| Ex. O4a | CoCl(Ph₃P)₃ | Olyelamine | ZnCl₂ | 10 | 30 | 50 |
| Ex. O5a | CoCl(Ph₃P)₃ | Olyelamine | ZnCl₂ | 10 | 80 | 97 |
| Ex. O6a | CoCl(Ph₃P)₃ | Olyelamine | ZnCl₂ | 25 | 0.1 | 1 |
| Ex. O7a | CoCl(Ph₃P)₃ | Olyelamine | ZnCl₂ | 25 | 0.5 | 11 |
| Ex. O1 | CoCl(Ph₃P)₃ | Olyelamine | ZnCl₂ | 25 | 1 | 18 |
| Ex. O8a | CoCl(Ph₃P)₃ | Olyelamine | ZnCl₂ | 25 | 10 | 50 |
| Ex. O9a | CoCl(Ph₃P)₃ | Olyelamine | ZnCl₂ | 25 | 72 | 99 |
| Ex. O10a | CoCl(Ph₃P)₃ | Olyelamine | ZnCl₂ | 40 | 0.02 | 2 |
| Ex. O11a | CoCl(Ph₃P)₃ | Olyelamine | ZnCl₂ | 40 | 0.2 | 10 |
| Ex. O12a | CoCl(Ph₃P)₃ | Olyelamine | ZnCl₂ | 40 | 0.45 | 22 |
| Ex. O13a | CoCl(Ph₃P)₃ | Olyelamine | ZnCl₂ | 40 | 8 | 48 |
| Ex. O14a | CoCl(Ph₃P)₃ | Olyelamine | ZnCl₂ | 40 | 55 | 98 |
| Ex. O15a | CoCl(Ph₃P)₃ | Olyelamine | ZnCl₂ | 65 | 0.01 | 2 |
| Ex. O16a | CoCl(Ph₃P)₃ | Olyelamine | ZnCl₂ | 65 | 0.1 | 12 |
| Ex. O17a | CoCl(Ph₃P)₃ | Olyelamine | ZnCl₂ | 65 | 0.25 | 18 |
| Ex. O18a | CoCl(Ph₃P)₃ | Olyelamine | ZnCl₂ | 65 | 3.5 | 52 |
| Ex. O19a | CoCl(Ph₃P)₃ | Olyelamine | ZnCl₂ | 65 | 10 | 58 |

| | Metal magnetic powder | | | | | Magnetic properties | |
|---|---|---|---|---|---|---|---|
| | Ratio of | | | Amphoteric metal | | Permeability | Magnetic loss |
| Sample | Co crystalline phase (%) | | | | Content ratio | μ′ | tanδ |
| No. | hcp-Co | fcc-Co | ε-Co | Type | (%) | at 5 GHz | at 5 GHz |
| Ex. O1a | 82 | 13 | 5 | Zn | 7 | 1.14 | 0.070 |
| Ex. O2a | 78 | 16 | 6 | Zn | 7 | 1.15 | 0.069 |
| Ex. O3a | 78 | 17 | 5 | Zn | 7 | 1.17 | 0.070 |
| Ex. O4a | 80 | 15 | 5 | Zn | 7 | 1.17 | 0.071 |
| Ex. O5a | 80 | 15 | 5 | Zn | 7 | 1.17 | 0.076 |
| Ex. O6a | 71 | 17 | 12 | Zn | 7 | 1.16 | 0.070 |
| Ex. O7a | 70 | 17 | 13 | Zn | 7 | 1.17 | 0.070 |
| Ex. O1 | 71 | 19 | 10 | Zn | 7 | 1.17 | 0.070 |
| Ex. O8a | 70 | 17 | 13 | Zn | 7 | 1.17 | 0.071 |
| Ex. O9a | 70 | 17 | 13 | Zn | 7 | 1.17 | 0.075 |
| Ex. O10a | 59 | 15 | 26 | Zn | 7 | 1.17 | 0.071 |
| Ex. O11a | 60 | 14 | 26 | Zn | 7 | 1.17 | 0.071 |
| Ex. O12a | 59 | 14 | 27 | Zn | 7 | 1.17 | 0.072 |
| Ex. O13a | 58 | 16 | 26 | Zn | 7 | 1.18 | 0.072 |
| Ex. O14a | 61 | 14 | 25 | Zn | 7 | 1.18 | 0.075 |
| Ex. O15a | 51 | 0 | 49 | Zn | 7 | 1.21 | 0.070 |
| Ex. O16a | 50 | 0 | 50 | Zn | 7 | 1.20 | 0.072 |
| Ex. O17a | 50 | 0 | 50 | Zn | 7 | 1.21 | 0.072 |
| Ex. O18a | 51 | 0 | 49 | Zn | 7 | 1.21 | 0.073 |
| Ex. O19a | 50 | 0 | 50 | Zn | 7 | 1.21 | 0.078 |

TABLE 11

| | Powder manufacturing conditions | | | | | Metal magnetic |
|---|---|---|---|---|---|---|
| | | | | Reaction | Reaction | powder |
| Sample | | | | temperature | time | D50 |
| No. | Precursor | Solvent | Additive | (° C.) | (h) | (nm) |
| Ex. T1a | CoCl(Ph₃P)₃ | THF | ZnCl₂ | 10 | 0.2 | 1 |
| Ex. T1b | CoCl(Ph₃P)₃ | THF | ZnCl₂ | 10 | 0.2 | 2 |
| Ex. T1c | CoCl(Ph₃P)₃ | THF | ZnCl₂ | 10 | 0.2 | 2 |
| Ex. T2a | CoCl(Ph₃P)₃ | THF | ZnCl₂ | 10 | 0.7 | 9 |
| Ex. T2b | CoCl(Ph₃P)₃ | THF | ZnCl₂ | 10 | 0.7 | 9 |
| Ex. T2c | CoCl(Ph₃P)₃ | THF | ZnCl₂ | 10 | 0.7 | 11 |
| Ex. T3a | CoCl(Ph₃P)₃ | THF | ZnCl₂ | 10 | 5 | 21 |
| Ex. T3b | CoCl(Ph₃P)₃ | THF | ZnCl₂ | 10 | 5 | 18 |
| Ex. T3c | CoCl(Ph₃P)₃ | THF | ZnCl₂ | 10 | 5 | 20 |
| Ex. T4a | CoCl(Ph₃P)₃ | THF | ZnCl₂ | 10 | 30 | 49 |
| Ex. T4b | CoCl(Ph₃P)₃ | THF | ZnCl₂ | 10 | 30 | 48 |
| Ex. T4c | CoCl(Ph₃P)₃ | THF | ZnCl₂ | 10 | 30 | 52 |
| Ex. T5a | CoCl(Ph₃P)₃ | THF | ZnCl₂ | 10 | 80 | 100 |
| Ex. T5b | CoCl(Ph₃P)₃ | THF | ZnCl₂ | 10 | 80 | 98 |
| Ex. T5c | CoCl(Ph₃P)₃ | THF | ZnCl₂ | 10 | 80 | 98 |
| Ex. T15a | CoCl(Ph₃P)₃ | THF | ZnCl₂ | 65 | 0.01 | 1 |
| Ex. T15b | CoCl(Ph₃P)₃ | THF | ZnCl₂ | 65 | 0.01 | 2 |
| Ex. T15c | CoCl(Ph₃P)₃ | THF | ZnCl₂ | 65 | 0.01 | 1 |
| Ex. T16a | CoCl(Ph₃P)₃ | THF | ZnCl₂ | 65 | 0.1 | 10 |
| Ex. T16b | CoCl(Ph₃P)₃ | THF | ZnCl₂ | 65 | 0.1 | 12 |
| Ex. T16c | CoCl(Ph₃P)₃ | THF | ZnCl₂ | 65 | 0.1 | 9 |
| Ex. T17a | CoCl(Ph₃P)₃ | THF | ZnCl₂ | 65 | 0.25 | 18 |
| Ex. T17b | CoCl(Ph₃P)₃ | THF | ZnCl₂ | 65 | 0.25 | 19 |
| Ex. T17c | CoCl(Ph₃P)₃ | THF | ZnCl₂ | 65 | 0.25 | 20 |
| Ex. T18a | CoCl(Ph₃P)₃ | THF | ZnCl₂ | 65 | 3.5 | 51 |
| Ex. T18b | CoCl(Ph₃P)₃ | THF | ZnCl₂ | 65 | 3.5 | 48 |
| Ex. T18c | CoCl(Ph₃P)₃ | THF | ZnCl₂ | 65 | 3.5 | 50 |
| Ex. T19a | CoCl(Ph₃P)₃ | THF | ZnCl₂ | 65 | 10 | 59 |
| Ex. T19b | CoCl(Ph₃P)₃ | THF | ZnCl₂ | 65 | 10 | 59 |
| Ex. T19c | CoCl(Ph₃P)₃ | THF | ZnCl₂ | 65 | 10 | 61 |

| | Metal magnetic powder | | | | | Magnetic properties | |
|---|---|---|---|---|---|---|---|
| | Ratio of | | | Amphoteric metal | | Permeability | Magnetic loss |
| Sample | Co crystalline phase (%) | | | | Content ratio | μ′ | tanδ |
| No. | hcp-Co | fcc-Co | ε-Co | Type | (%) | at 5 GHz | at 5 GHz |
| Ex. T1a | 81 | 19 | 0 | Zn | 7 | 1.15 | 0.070 |
| Ex. T1b | 81 | 19 | 0 | Zn | 3 | 1.15 | 0.071 |
| Ex. T1c | 81 | 19 | 0 | Zn | 1 | 1.16 | 0.071 |
| Ex. T2a | 81 | 19 | 0 | Zn | 7 | 1.15 | 0.069 |
| Ex. T2b | 83 | 17 | 0 | Zn | 3 | 1.16 | 0.070 |
| Ex. T2c | 82 | 18 | 0 | Zn | 1 | 1.16 | 0.071 |
| Ex. T3a | 82 | 18 | 0 | Zn | 7 | 1.16 | 0.070 |
| Ex. T3b | 82 | 18 | 0 | Zn | 3 | 1.16 | 0.070 |
| Ex. T3c | 80 | 20 | 0 | Zn | 1 | 1.18 | 0.071 |
| Ex. T4a | 82 | 18 | 0 | Zn | 7 | 1.16 | 0.071 |
| Ex. T4b | 81 | 19 | 0 | Zn | 3 | 1.17 | 0.071 |
| Ex. T4c | 83 | 17 | 0 | Zn | 1 | 1.17 | 0.072 |
| Ex. T5a | 79 | 21 | 0 | Zn | 7 | 1.17 | 0.075 |
| Ex. T5b | 81 | 19 | 0 | Zn | 3 | 1.17 | 0.077 |
| Ex. T5c | 79 | 21 | 0 | Zn | 1 | 1.18 | 0.078 |
| Ex. T15a | 52 | 48 | 0 | Zn | 7 | 1.20 | 0.071 |
| Ex. T15b | 53 | 47 | 0 | Zn | 3 | 1.20 | 0.071 |
| Ex. T15c | 51 | 49 | 0 | Zn | 1 | 1.22 | 0.072 |
| Ex. T16a | 50 | 50 | 0 | Zn | 7 | 1.20 | 0.073 |
| Ex. T16b | 50 | 50 | 0 | Zn | 3 | 1.20 | 0.075 |
| Ex. T16c | 50 | 50 | 0 | Zn | 1 | 1.21 | 0.075 |
| Ex. T17a | 51 | 49 | 0 | Zn | 7 | 1.21 | 0.072 |
| Ex. T17b | 51 | 49 | 0 | Zn | 3 | 1.23 | 0.072 |
| Ex. T17c | 52 | 48 | 0 | Zn | 1 | 1.23 | 0.073 |
| Ex. T18a | 52 | 48 | 0 | Zn | 7 | 1.20 | 0.075 |
| Ex. T18b | 53 | 47 | 0 | Zn | 3 | 1.21 | 0.075 |
| Ex. T18c | 50 | 50 | 0 | Zn | 1 | 1.22 | 0.076 |
| Ex. T19a | 51 | 49 | 0 | Zn | 7 | 1.20 | 0.079 |
| Ex. T19b | 51 | 49 | 0 | Zn | 3 | 1.21 | 0.079 |
| Ex. T19c | 50 | 50 | 0 | Zn | 1 | 1.21 | 0.080 |

TABLE 12

| | Powder manufacturing conditions | | | | | Metal magnetic |
|---|---|---|---|---|---|---|
| | | | | Reaction | Reaction | powder |
| Sample | | | | temperature | time | D50 |
| No. | Precursor | Solvent | Additive | (° C.) | (h) | (nm) |
| Ex. O1a | CoCl(Ph₃P)₃ | Olyelamine | ZnCl₂ | 10 | 0.2 | 1 |
| Ex. O1b | CoCl(Ph₃P)₃ | Olyelamine | ZnCl₂ | 10 | 0.2 | 2 |
| Ex. O1c | CoCl(Ph₃P)₃ | Olyelamine | ZnCl₂ | 10 | 0.2 | 3 |
| Ex. O2a | CoCl(Ph₃P)₃ | Olyelamine | ZnCl₂ | 10 | 0.7 | 10 |
| Ex. O2b | CoCl(Ph₃P)₃ | Olyelamine | ZnCl₂ | 10 | 0.7 | 10 |
| Ex. O2c | CoCl(Ph₃P)₃ | Olyelamine | ZnCl₂ | 10 | 0.7 | 11 |
| Ex. O3a | CoCl(Ph₃P)₃ | Olyelamine | ZnCl₂ | 10 | 5 | 21 |
| Ex. O3b | CoCl(Ph₃P)₃ | Olyelamine | ZnCl₂ | 10 | 5 | 20 |
| Ex. O3c | CoCl(Ph₃P)₃ | Olyelamine | ZnCl₂ | 10 | 5 | 18 |
| Ex. O4a | CoCl(Ph₃P)₃ | Olyelamine | ZnCl₂ | 10 | 30 | 50 |
| Ex. O4b | CoCl(Ph₃P)₃ | Olyelamine | ZnCl₂ | 10 | 30 | 52 |
| Ex. O4c | CoCl(Ph₃P)₃ | Olyelamine | ZnCl₂ | 10 | 30 | 49 |
| Ex. O5a | CoCl(Ph₃P)₃ | Olyelamine | ZnCl₂ | 10 | 80 | 97 |
| Ex. O5b | CoCl(Ph₃P)₃ | Olyelamine | ZnCl₂ | 10 | 80 | 99 |
| Ex. O5c | CoCl(Ph₃P)₃ | Olyelamine | ZnCl₂ | 10 | 80 | 98 |

| | Metal magnetic powder | | | | | Magnetic properties | |
|---|---|---|---|---|---|---|---|
| | Ratio of | | | Amphoteric metal | | Permeability | Magnetic loss |
| Sample | Co crystalline phase (%) | | | | Content ratio | μ′ | tanδ |
| No. | hcp-Co | fcc-Co | ε-Co | Type | (%) | at 5 GHz | at 5 GHz |
| Ex. O1a | 82 | 13 | 5 | Zn | 7 | 1.14 | 0.070 |
| Ex. O1b | 81 | 12 | 7 | Zn | 3 | 1.14 | 0.071 |
| Ex. O1c | 83 | 15 | 2 | Zn | 1 | 1.15 | 0.072 |
| Ex. O2a | 78 | 16 | 6 | Zn | 7 | 1.15 | 0.069 |
| Ex. O2b | 77 | 16 | 7 | Zn | 3 | 1.16 | 0.070 |
| Ex. O2c | 79 | 17 | 4 | Zn | 1 | 1.17 | 0.070 |
| Ex. O3a | 78 | 17 | 5 | Zn | 7 | 1.17 | 0.070 |
| Ex. O3b | 79 | 17 | 4 | Zn | 3 | 1.18 | 0.071 |
| Ex. O3c | 80 | 15 | 5 | Zn | 1 | 1.18 | 0.072 |
| Ex. O4a | 80 | 15 | 5 | Zn | 7 | 1.17 | 0.071 |
| Ex. O4b | 79 | 16 | 5 | Zn | 3 | 1.17 | 0.073 |
| Ex. O4c | 81 | 17 | 2 | Zn | 1 | 1.18 | 0.073 |
| Ex. O5a | 80 | 15 | 5 | Zn | 7 | 1.17 | 0.076 |
| Ex. O5b | 80 | 15 | 5 | Zn | 3 | 1.17 | 0.076 |
| Ex. O5c | 79 | 17 | 4 | Zn | 1 | 1.19 | 0.077 |

From the results shown in Tables 8 to 12, it has been found that the ratios of the Co crystalline phases can be controlled by the solvent used at the time of liquid phase thermal decomposition accompanied by a disproportionation reaction and the reaction temperature. In particular, it has been found that the sub-phase is more likely to be produced as the reaction temperature is increased, and the permeability μ′ in the high frequency band is further improved by making the composite magnetic body (that is, the metal magnetic powder) include the sub-phase.

### Experiment 8

In Experiment 8, a metal magnetic powder was manufactured under the same conditions as those in Example E3 in Experiment 1, and then, composite magnetic bodies according to Examples E3-1 to E3-5 were manufactured by changing a compounding ratio of the metal magnetic powder. The compounding ratio of the metal magnetic powder in each of Examples was controlled to make a content ratio of nanoparticles in the composite magnetic body have a value shown in Table 13. Manufacturing conditions other than the compounding ratio of the metal magnetic powder were the same as those in Example E3.

In Experiment 8, composite magnetic bodies according to Comparative Examples AA3-1 to A3-5 were also manufactured. In each of Comparative Examples A3-1 to A3-5, a metal magnetic powder was manufactured without adding an amphoteric metal under the same conditions as those in Comparative Example A3 in Experiment 1, and a composite magnetic body was obtained by adjusting a compounding ratio of the metal magnetic powder to make the content ratio of nanoparticles in the composite magnetic body have a value shown in Table 13. Manufacturing conditions other than the compounding ratio of the metal magnetic powder were the same as those in Comparative Example A3

In Experiment 8, a cross section of the manufactured composite magnetic body was observed with TEM, and an area ratio of the metal magnetic powder (nanoparticles) contained in the composite magnetic body was measured. As a result, it has been confirmed that the area ratio of the nanoparticles coincides with a target value (vol %) shown in Table 13 in each of Examples and each of Comparative Examples.

In general, when the content ratio (packing rate) of the magnetic powder in the composite magnetic body is increased, the permeability increases, magnetic loss properties tend to deteriorate (that is, the magnetic loss increases). In Experiment 8, a criterion for determination of magnetic properties was provided for each content ratio of nanoparticles in consideration of a change in magnetic properties due to the increase or decrease in the packing rate. Specifically, a sample satisfying the following requirements was determined as “good” in Experiment 8.
Content ratio of nanoparticles of 10 vol %: 1.05≤μ′, tanδ≤0.080
Content ratio of nanoparticles of 20 vol %: 1.20≤μ′, tanδ≤0.110
Content ratio of nanoparticles of 30 vol %: 1.40≤μ′, tanδ≤0.140
Content ratio of nanoparticles of 40 vol %: 1.60≤μ′, tanδ≤0.170
Content ratio of nanoparticles of 50 vol %: 1.80≤μ′, tanδ≤0.200
Content ratio of nanoparticles of 60 vol %: 2.00≤μ′, tanδ≤0.230
Evaluation results of Experiment 8 are shown in Table 13.

TABLE 13

| | | | | | | | | Composite magnetic | | |
|---|---|---|---|---|---|---|---|---|---|---|
| | Powder manufacturing conditions | | | Metal magnetic powder | | | | body | Magnetic properties | |
| | | Reaction | Reaction | Nanoparticles | | Amphoteric metal | | Content ratio | Permeability | Magnetic loss |
| Sample | | temperature | time | D50 | Main | | Content ratio | of nanoparticles | μ′ | tanδ |
| No. | Additive | (° C.) | (h) | (nm) | phase | Type | (%) | (vol %) | at 5 GHz | at 5 GHz |
| Comp. Ex. A3 | — | 25 | 1 | 21 | hcp-Co | — | 0 | 10 | 1.24 | 0.087 |
| Comp. Ex. A3-1 | — | 25 | 1 | 21 | hcp-Co | — | 0 | 20 | 1.57 | 0.163 |
| Comp. Ex. A3-2 | — | 25 | 1 | 21 | hcp-Co | — | 0 | 30 | 2.01 | 0.226 |
| Comp. Ex. A3-3 | — | 25 | 1 | 21 | hcp-Co | — | 0 | 40 | 2.56 | 0.274 |
| Comp. Ex. A3-4 | — | 25 | 1 | 21 | hcp-Co | — | 0 | 50 | 3.22 | 0.310 |
| Comp. Ex. A3-5 | — | 25 | 1 | 21 | hcp-Co | — | 0 | 60 | 3.96 | 0.336 |
| Ex. E3 | ZnCl₂ | 25 | 1 | 19 | hcp-Co | Zn | 7 | 10 | 1.15 | 0.068 |
| Ex. E3-1 | ZnCl₂ | 25 | 1 | 19 | hcp-Co | Zn | 7 | 20 | 1.33 | 0.098 |
| Ex. E3-2 | ZnCl₂ | 25 | 1 | 19 | hcp-Co | Zn | 7 | 30 | 1.53 | 0.128 |
| Ex. E3-3 | ZnCl₂ | 25 | 1 | 19 | hcp-Co | Zn | 7 | 40 | 1.76 | 0.147 |
| Ex. E3-4 | ZnCl₂ | 25 | 1 | 19 | hcp-Co | Zn | 7 | 50 | 2.01 | 0.173 |
| Ex. E3-5 | ZnCl₂ | 25 | 1 | 19 | hcp-Co | Zn | 7 | 60 | 2.29 | 0.191 |

From the results shown in Table 13, in Examples E3-1 to E3-5 in which the content ratio of nanoparticles in the composite magnetic body was changed, it was also possible to reduce the magnetic loss in as compared with each of Comparative Examples while securing the high permeability μ′.

### Experiment 9

In Experiment 9, metal magnetic powders according to Examples were manufactured under manufacturing conditions shown in Table 14, and composite magnetic bodies according to Examples were manufactured using the metal magnetic powders. In all of Examples in Experiment 9, the precursor was CoCl(Ph₃P)₃, the solvent was ethanol, the reaction temperature was set to the room temperature (25° C.), and the reaction time was set to 1 h although not shown in Table 14. In the manufacturing of the metal magnetic powder in each of Examples, a timing of adding the additive was set as shown in Table 14. For example, when the timing of adding the additive was 0.5 h, the additive was put into the reaction solution after a lapse of 0.5 h from the start of the reaction, and then, the reaction was further continued for 0.5 h.

In addition, the dispersion treatment at the time of manufacturing the composite magnetic body was changed to media dispersion using a bead mill in a part of Examples in Experiment 9. In the media dispersion, ZrO₂ beads having an average size of 0.2 mm were used, and the time for the dispersion treatment was set to values shown in Table 14. Manufacturing conditions other than the above were similar as those in Experiment 1.

Evaluation results of Examples in Experiment 9 are shown in Table 14. Note that a cross section of the composite magnetic body was analyzed by mapping analysis using TEM-EDS to identify existing locations of the amphoteric metal in Experiment 9. In the item “Detection site of the amphoteric metal” in Table 14, “Y” is written at a site where the amphoteric metal is detected, and “−” is written at a site where no amphoteric metal is detected. In each Example in Experiment 9, the diffraction peaks of the amphoteric metal was detected in an XRD pattern, and the amphoteric metal was present as metal crystals.

TABLE 14

| | Manufacturing conditions | | | | | | |
|---|---|---|---|---|---|---|---|
| | Powder | | | Composite magnetic body | | Composite magnetic body | |
| | Additive | | Reaction | Dispersion conditions | | Nanoparticles | |
| Sample | | Timing | time | | Treatment | D50 | Main |
| No. | Type | (h) | (h) | Method | time (min) | (nm) | phase |
| Ex. E3 | ZnCl₂ | 0.00 | 1 | Ultrasonic | 10 | 19 | hcp-Co |
| Ex. AZ1 | ZnCl₂ | 0.50 | 1 | Ultrasonic | 10 | 21 | hcp-Co |
| Ex. AZ2 | ZnCl₂ | 0.75 | 1 | Ultrasonic | 10 | 20 | hcp-Co |
| Ex. AZ3 | ZnCl₂ | 0.75 | 1 | Media | 10 | 22 | hcp-Co |
| Ex. AZ4 | ZnCl₂ | 0.75 | 1 | Media | 30 | 19 | hcp-Co |
| Ex. AZ5 | ZnCl₂ | 0.50 | 1 | Media | 10 | 19 | hcp-Co |
| Ex. AZ6 | ZnCl₂ | 0.50 | 1 | Media | 30 | 21 | hcp-Co |
| Ex. F3 | AlCl₃ | 0.00 | 1 | Ultrasonic | 10 | 19 | hcp-Co |
| Ex. AA1 | AlCl₃ | 0.50 | 1 | Ultrasonic | 10 | 18 | hcp-Co |
| Ex. AA2 | AlCl₃ | 0.75 | 1 | Ultrasonic | 10 | 18 | hcp-Co |
| Ex. AA3 | AlCl₃ | 0.75 | 1 | Media | 10 | 19 | hcp-Co |
| Ex. AA4 | AlCl₃ | 0.75 | 1 | Media | 30 | 19 | hcp-Co |
| Ex. AA5 | AlCl₃ | 0.50 | 1 | Media | 10 | 19 | hcp-Co |
| Ex. AA6 | AlCl₃ | 0.50 | 1 | Media | 30 | 22 | hcp-Co |
| Ex. G3 | SnCl₂ | 0.00 | 1 | Ultrasonic | 10 | 18 | hcp-Co |
| Ex. AS1 | SnCl₂ | 0.50 | 1 | Ultrasonic | 10 | 19 | hcp-Co |
| Ex. AS2 | SnCl₂ | 0.75 | 1 | Ultrasonic | 10 | 21 | hcp-Co |
| Ex. AS3 | SnCl₂ | 0.75 | 1 | Media | 10 | 21 | hcp-Co |
| Ex. AS4 | SnCl₂ | 0.75 | 1 | Media | 30 | 22 | hcp-Co |
| Ex. AS5 | SnCl₂ | 0.50 | 1 | Media | 10 | 21 | hcp-Co |
| Ex. AS6 | SnCl₂ | 0.50 | 1 | Media | 30 | 20 | hcp-Co |
| Ex. H3 | PbCl₂ | 0.00 | 1 | Ultrasonic | 10 | 22 | hcp-Co |
| Ex. AP1 | PbCl₂ | 0.50 | 1 | Ultrasonic | 10 | 21 | hcp-Co |
| Ex. AP2 | PbCl₂ | 0.75 | 1 | Ultrasonic | 10 | 18 | hcp-Co |
| Ex. AP3 | PbCl₂ | 0.75 | 1 | Media | 10 | 20 | hcp-Co |
| Ex. AP4 | PbCl₂ | 0.75 | 1 | Media | 30 | 20 | hcp-Co |
| Ex. AP5 | PbCl₂ | 0.50 | 1 | Media | 10 | 20 | hcp-Co |
| Ex. AP6 | PbCl₂ | 0.50 | 1 | Media | 30 | 21 | hcp-Co |

| | Composite magnetic body | | | | | | |
|---|---|---|---|---|---|---|---|
| | Amphoteric metal | | | | | Magnetic properties | |
| | | Content | Detection site | | | Permeability | Magnetic loss |
| Sample | | ratio | Inside | Particle | | μ′ | tanδ |
| No. | Type | (%) | particle | surface | In resin | at 5 GHz | at 5 GHz |
| Ex. E3 | Zn | 7 | Y | — | — | 1.15 | 0.068 |
| Ex. AZ1 | Zn | 7 | Y | Y | — | 1.16 | 0.069 |
| Ex. AZ2 | Zn | 7 | — | Y | — | 1.14 | 0.067 |
| Ex. AZ3 | Zn | 7 | — | Y | Y | 1.16 | 0.069 |
| Ex. AZ4 | Zn | 7 | — | — | Y | 1.14 | 0.068 |
| Ex. AZ5 | Zn | 7 | Y | Y | Y | 1.15 | 0.068 |
| Ex. AZ6 | Zn | 7 | Y | — | Y | 1.15 | 0.068 |
| Ex. F3 | Al | 7 | Y | — | — | 1.17 | 0.070 |
| Ex. AA1 | Al | 7 | Y | Y | — | 1.16 | 0.070 |
| Ex. AA2 | Al | 7 | — | Y | — | 1.17 | 0.071 |
| Ex. AA3 | Al | 7 | — | Y | Y | 1.16 | 0.070 |
| Ex. AA4 | Al | 7 | — | — | Y | 1.17 | 0.071 |
| Ex. AA5 | Al | 7 | Y | Y | Y | 1.17 | 0.069 |
| Ex. AA6 | Al | 7 | Y | — | Y | 1.17 | 0.069 |
| Ex. G3 | Sn | 7 | Y | — | — | 1.16 | 0.072 |
| Ex. AS1 | Sn | 7 | Y | Y | — | 1.15 | 0.072 |
| Ex. AS2 | Sn | 7 | — | Y | — | 1.16 | 0.072 |
| Ex. AS3 | Sn | 7 | — | Y | Y | 1.15 | 0.073 |
| Ex. AS4 | Sn | 7 | — | — | Y | 1.15 | 0.071 |
| Ex. AS5 | Sn | 7 | Y | Y | Y | 1.17 | 0.071 |
| Ex. AS6 | Sn | 7 | Y | — | Y | 1.17 | 0.071 |
| Ex. H3 | Pb | 7 | Y | — | — | 1.17 | 0.071 |
| Ex. AP1 | Pb | 7 | Y | Y | — | 1.18 | 0.072 |
| Ex. AP2 | Pb | 7 | — | Y | — | 1.18 | 0.070 |
| Ex. AP3 | Pb | 7 | — | Y | Y | 1.18 | 0.072 |
| Ex. AP4 | Pb | 7 | — | — | Y | 1.16 | 0.072 |
| Ex. AP5 | Pb | 7 | Y | Y | Y | 1.17 | 0.071 |
| Ex. AP6 | Pb | 7 | Y | — | Y | 1.17 | 0.070 |

From the results shown in Table 14, it has been found that the existing location of the amphoteric metal can be controlled by the timing of adding the additive of the amphoteric metal and conditions of the dispersion treatment. Then, both a high permeability and a low magnetic loss could be achieved in a high frequency band even when the existing location of the amphoteric metal was changed.

### DESCRIPTION OF THE REFERENCE NUMERICAL

1 . . . metal magnetic powder
2 . . . nanoparticles
   3, 3a, 3b, 3c . . . crystal grain of amphoteric metal

10 . . . composite magnetic body
6 . . . resin

100 . . . inductor
50 . . . coil portion
60, 80 . . . external electrode

What is claimed is:

1. A metal magnetic powder comprising Co as a main component,
wherein the metal magnetic powder comprises metal nanoparticles having a mean particle size (D50) of 1 nm or more and 100 nm or less,
wherein each of the metal nanoparticles comprises hcp-Co as a main phase, and
wherein the metal magnetic powder includes at least one amphoteric metal.

2. The metal magnetic powder according to claim 1, wherein the amphoteric metal is present on a surface and/or inside of at least one of the metal nanoparticles.

3. The metal magnetic powder according to claim 1, wherein
W_{AM}/(W_{Co}+W_{AM}) is 0.001% or more and 10% or less
where W_{Co} denotes a content rate of Co, and W_{AM} denotes a content rate of amphoteric metals, in the metal magnetic powder.

4. The metal magnetic powder according to claim 1, comprising Zn as the amphoteric metal.

5. The metal magnetic powder according to claim 1, further comprising fcc-Co and/or ϵ-Co as a sub-phase.

6. A composite magnetic body comprising:
a metal magnetic powder including Co as a main component; and
a resin,
wherein the metal magnetic powder comprises metal nanoparticles having a mean particle size (D50) of 1 nm or more and 100 nm or less,
each of the metal nanoparticles comprises hcp-Co as a main phase, and
the composite magnetic body includes at least one amphoteric metal.

7. The composite magnetic body according to claim 6, wherein
W_{AM}/(W_{Co}+W_{AM}) is 0.001% or more and 10% or less
where W_{Co} denotes a content rate of Co, and W_{AM} denotes a content rate of amphoteric metals, in the metal magnetic powder.

8. The composite magnetic body according to claim 6, comprising Zn as the amphoteric metal.

9. The composite magnetic body according to claim 6, wherein the metal magnetic powder comprises fcc-Co and/or ϵ-Co as a sub-phase.

10. An electronic component comprising the metal magnetic powder according to claim 1.

11. An electronic component comprising the composite magnetic body according to claim 6.
